(19) United States
(12) Patent Application Publication
(10) Pub. No.: US 2023/0388480 A1
(43) Pub. Date: Nov. 30, 2023

(54) LIGHTFIELD DISPLAYS

(71) Applicant: Timothy John Borer, Cambridge (GB)

(72) Inventor: Timothy John Borer, Cambridge (GB)

(21) Appl. No.: 18/199,790

(22) Filed: May 19, 2023

(30) Foreign Application Priority Data
May 24, 2022 (GB) 2207566.7

(51) Int. Cl. H04N 13/395; H04N 13/32; H04N 13/346

(52) U.S. Cl. CPC H04N 13/395; H04N 13/32; H04N 13/346

(57) ABSTRACT

Lightfield displays for generating a 3D image comprise a 2D array of hogels. Each hogel comprises a 2D array of one or more pixels for generating light rays, and a light distribution control arrangement for controlling in 2D the angular distribution of the light rays from the array which are emitted by the hogel. The 2D array of each hogel is arranged to generate light rays which correspond to an elementary image assigned to the hogel, with each elementary image having a central axis which passes through a center of the image and extends perpendicular to the image. A plurality of the hogels have different lateral offsets between the light distribution control arrangement and the central axis of the respective elementary image.

### RELATED APPLICATION

This application claims priority to UK Patent Application No. 2207566.7, filed on May 24, 2022, the disclosure of which is incorporated herein by reference.

### FIELD

The present disclosure relates to lightfield displays and more particularly to enabling lightfield displays to present a greater depth of field.

### SUMMARY

Lightfield displays for generating 3D images are disclosed. Lightfield displays comprise a 2D array of hogels. Each hogel comprises a 2D array of one or more pixels for generating light rays, and a light distribution control arrangement for controlling in 2D the angular distribution of the light rays from the array which are emitted by the hogel. The 2D array of each hogel is arranged to generate light rays which correspond to an elementary image assigned to the hogel, with each elementary image having a central axis which passes through a center of the image and extends perpendicular to the image. A plurality of the hogels have different lateral offsets between the light distribution control arrangement and the central axis of the respective elementary image.

### BRIEF DESCRIPTION OF THE DRAWINGS

FIG. 1 is a diagram illustrating the principle of a lightfield display.

FIG. 2 is an illustration of a pinhole parallax display.

FIG. 3 is a diagram showing light ray generation in a pinhole parallax barrier display.

FIG. 4 is an example of a 3D scene.

FIG. 5 shows examples of elementary images behind each pinhole of a lightfield display.

FIG. 6 shows a comparison of the top left and bottom right elementary images shown in FIG. 5.

FIG. 7 is a diagram of a light field display using an array of microlenses.

FIG. 8 is a series of diagrams to illustrate formation of an image by the human eye or a camera.

FIG. 9 is two diagrams showing three existing pinhole hogels (top) and three pinholes implementing 3:1 angular subsampling (bottom).

FIG. 10 is two diagrams showing four existing pinhole hogels (top) and four pinholes implementing 2:1 angular subsampling (bottom).

FIG. 11 is two diagrams showing four existing pinhole hogels (top) and four pinholes implementing 4:1 angular subsampling (bottom).

FIGS. 12, 13, and 14 are a series of diagrams to illustrate different emanating regions.

FIG. 15 is a diagram showing angular subsampling by modulating the position of a hogel lens.

FIG. 16 is a diagram showing 3:1 angular subsampling using offsetting prisms.

FIGS. 17, 18, and 19 are diagrams showing 3:1, 2:1 and 4:1 angular subsampling, respectively, using pixel array offsetting.

FIG. 20 is a diagram showing angular subsampling using pixel array offsetting together with microlenses.

FIG. 21 is a diagram showing angular subsampling using modulation of the position of the elementary image.

FIG. 22 is a diagram showing angular subsampling using modulation of the position of the elementary image together with microlenses.

FIG. 23 is a diagram showing elementary pixel coordinates for a physical lightfield display.

FIG. 24 is a diagram showing elementary pixel coordinates for a notional lightfield display.

FIG. 25 is a diagram showing the notional elementary pixel coordinates of FIG. 24 mapped to the physical display of FIG. 23.

FIG. 26 is a diagram showing spatial subsampling phases.

FIG. 27 is a diagram showing labels for the spatial subsampling phases of FIG. 26.

FIG. 28 is a diagram showing equivalent subsampling lightfield displays using a linear phase order.

FIG. 29 is a diagram showing equivalent subsampling lightfield displays using a permuted phase order.

FIG. 30 is a diagram illustrating determination of the f-number of a microlens array.

FIG. 31 is a diagram showing elementary pixel coordinates for a physical lightfield display (6 top left hogels only).

FIG. 32 is a diagram showing elementary pixel coordinates for a notional lightfield display emulated using 4:1 angular subsampling (6 top left hogels only).

FIG. 33 is a diagram showing the notional elementary pixel coordinates of FIG. 32 mapped onto the physical display of FIG. 25.

FIG. 34 is a diagram showing an example of subsampling phases for mapping notional elementary pixel coordinates using 4:1 angular subsampling.

FIG. 35 is a diagram showing phase permutation in two dimensions using a Hilbert scan and bit reversal.

FIG. 36 is a diagram showing another example of subsampling phases for mapping notional elementary pixel coordinates using 4:1 angular subsampling.

FIG. 37 is a diagram showing an example of subsampling phases for mapping notional elementary pixel coordinates using 8:1 angular subsampling.

FIG. 38 is a diagram showing the notional elementary pixel coordinates mapped onto a physical display.

FIG. 39 is a diagram showing elementary pixel coordinates for one hogel of a notional lightfield display.

FIG. 40 is a diagram showing the mapping of the notional pixel positions of FIG. 39 onto physical pixel positions.

FIG. 41 is a diagram showing temporal subsampling phases.

FIG. 42 is a diagram showing labels for the temporal subsampling phases of FIG. 41.

FIG. 43 is a diagram showing elementary pixel coordinates for a physical lightfield display (with a 2×2 pixel array per hogel over four frames).

FIG. 44 is a diagram showing elementary pixel coordinates for a notional lightfield display using spatiotemporal subsampling over four frames.

FIG. 45 is a diagram showing elementary pixel coordinates for a single hogel of a notional light field display using spatiotemporal subsampling.

FIG. 46 is a diagram showing the notional elementary pixel coordinates of FIG. 45 mapped to frames of the physical display shown in FIG. 43.

FIG. 47 is a diagram showing spatiotemporal subsampling phases over 4 frames.

FIG. 48 is a diagram showing elementary pixel coordinates for a notional lightfield display emulated using spatiotemporal subsampling (top left hogel only).

FIG. 49 is a diagram showing subsampling phases for mapping notional to physical elementary pixel coordinates using spatiotemporal subsampling.

FIG. 50 is a diagram showing elementary pixel coordinates from a notional lightfield display mapped to a physical display using spatiotemporal subsampling (top left hogel only).

FIG. 51 is a diagram of a display showing RGB color stripes.

FIG. 52 is a diagram of a color display using a Bayer pattern.

FIG. 53 is a diagram of a display comprising RGB and white pixels.

### DESCRIPTION

Lightfield displays, invented by Gabriel Lippmann in 1908, can, in principle, present natural looking, still or moving, three-dimensional (3D) images that change perspective as the viewer moves. Importantly, they also allow the viewer to focus at different depths within the image. Neither of these features is attainable using known stereoscopic 3D displays, such as are used for 3D movies. A fuller description and explanation of lightfield displays is provided in “Sampling requirements for lightfield displays with a large depth of field,” by Tim Borer, Proc. SPIE 10997, Three-Dimensional Imaging, Visualization, and Display 2019, 1099704 (14 May 2019); doi.org/10.1117/12.2522372 (referred to herein as “The Borer article”).

An ideal lightfield display may be envisaged as presenting an image within a frame. Images behind the display (i.e. behind the “frame”) would appear as if viewed through an open window. The display would allow multiple simultaneous viewers, each of whom would see a slightly different view depending on their position. A viewer could focus at any depth, with each eye seeing a slightly different image. The different parallax seen by each eye, combined with the ability to change focus, gives a strong sensation of depth. If a viewer moved their head, horizontally or vertically, they would see the scene from a different viewpoint, which is known as “motion parallax”. Not only would a lightfield display enable, to some extent, a viewer to look behind objects, it would also allow, for example, the image of a lake to sparkle, or an image to appear in a reflecting surface, as the head moves. Similarly, the display could provide 3D images in front of the display or, indeed, objects apparently projecting through the display. The viewer would not be able to distinguish the image from reality. Clearly such a display offers a qualitatively different experience, much more realistic and “immersive”, than a known 2D display such as a television.

Lightfield displays can overcome many of the problems of known 3D stereoscopic (or “stereo”) displays, i.e. displays which show slightly different views, with different parallax, to each eye. Such 3D stereo displays were commonly implemented in high quality televisions prior to about 2017 but were not a commercial success. Their requirement to wear glasses or a headset, the lack of motion parallax (i.e. changes to the image as the head moves), the lack of ability of the eye to focus at different depths, and the accommodation/vergence conflict were, inter alia, the cause. The latter problem arises because the vergence (i.e. the degree to which the optic axis of the two eyes converge or diverge depending on the depth they are looking at) differs from the focal length of the eye. Accommodation/vergence conflict is a serious problem for the viewer because it causes discomfort, or in extreme cases, nausea. Consequently, it may limit the time for which a viewer may comfortably watch 3D stereo pictures.

There are many applications for lightfield displays. They could, for example, replace 2D displays used in television, cinema, and mobile phones. They could provide a better video conferencing experience. And they would be useful for visualizing complex data in 3D.

A major problem in producing a lightfield display with a large depth of field is the enormous number of pixels required. Lightfield displays are based on 2D displays but require many more pixels than a 2D display in order to produce the illusion of depth. If there are insufficient pixels then, beyond a certain depth, the image will start to become blurry and out of focus. The depth of field of a lightfield display is the distance behind or in front of the display beyond which the 3D image starts to blur. Currently available lightfield displays typically have depths of field of only a few centimeters. For example, the Looking Glass Factory's “Looking Glass 8 k Immersive Display” is reported as having a depth of field of ±8 cm. The present disclosure shows how to produce a very much greater depth of field from the same number of pixels in the 2D display. This allows a lightfield display to present a much more realistic and immersive image.

FIG. 1 illustrates the principle of a lightfield display. The aim is to reproduce the angles and the intensities of all the light rays from a scene as they would pass through a frame surrounding the display. Hence, each point on the display must reproduce rays, with a range of intensities and angles that would pass through that point from a real object. For example, rays from the tip of the central turret are shown “passing through” three points on the display. At each point on the display, the angle of these rays to the display normal, and their intensity, are different. In practice rays from the turret would “pass through” all points of the display and would have to be reproduced with the appropriate angle and intensity. If this is achieved with sufficient accuracy then the viewer in front of the display would be unable to distinguish a virtual image of a scene, produced by a lightfield display, from reality.

Focusing on a lightfield display is performed only in the eye of the observer. This means that every part of the scene will appear to be in focus, just as it does in reality. By contrast photographs and movies ubiquitously have substantial regions that are out of focus.

A lightfield display, like a known 2D display such as a television, may be implemented as a flat, 2D, panel. A pixel in an (ideal) known 2D display has the same radiance viewed from any angle (this is known as a Lambertian emitter). So, the luminance of the 2D image it generates looks the same brightness from any angle. At a given instant a 2D image may therefore be defined as the luminance of each point on the display, i.e. as a function of two variables (the position on the display, such as horizontal and vertical co-ordinates). A lightfield display, by contrast, also controls the luminous intensity of the light from each point on the display as a function of the angle of the rays it emits. Therefore, a lightfield image, at a given instant, is defined by its luminous intensity as a function of four variables. They may comprise, for example: a position on the display (two variables), and, for that position, two angles such as the polar angle (i.e. the angle relative to the display normal) and the azimuthal angle from a conventional spherical coordinate system. Rather than use conventional spherical angular coordinates it may be preferable, for lightfield displays, to use alternative angular coordinates. These could be the angles between the ray projected on to the x-z (i.e. horizontal-depth) plane and the z (depth) axis and, similarly, the angle between the ray projected on to the y-z (i.e. vertical-depth) plane and the z (depth) axis. Two angular co-ordinates are required irrespective of the angular co-ordinate system that is used. Like known 2D displays, lightfield displays may be implemented in other shapes, such as curved, not just as plane surfaces. The present disclosure refers to planar displays, for simplicity, but may equally well be applied, mutatis mutandis, to other shaped surfaces.

A 3D scene, that could be presented by a lightfield display, may be represented by a mathematical 3D scene model (as is well known in the field of computer graphics), which represents the surfaces of all the objects in a scene. It contains the set of all points on the surfaces of the objects in the scene, along with their properties (such as reflectivity) that are needed to generate the image. Any point in the scene model may contribute to the intensity of rays from every point on the display. FIG. 1 shows examples of rays emanating from a scene and intersecting the display surface at a number of points. A point on the scene, for example the tip of the central turret, may reflect or emit rays that intersect every point on the display surface (even though only three such example rays are shown in FIG. 1). Sometimes a scene point will not contribute to rays emitted from every point on the display, for example, if it is behind another object (occluded) so that its rays cannot reach the display surface. The intensity of a ray emitted from a scene point is proportional to the number of photons per unit of time travelling from the scene point, to the display, in a particular direction.

Signals to drive a lightfield display may be generated by rendering a 3D scene model, or otherwise. Rendering a scene model is the process of calculating the angles and intensity of all the rays from the scene which intersect the display surface. Algorithms for rendering an image from a 3D model, such as ray tracing, have been well known for many years and are used, for example, in CGI effects for movies and for computer games. The intensity of the ray from a scene point represents the number of photons per second in that ray. Each point in the scene may be rendered independently of other scene points because contributions to the intensity of each ray (i.e. photons per second) may simply be added together.

The description herein includes several special cases of scenes. Sometimes the scene comprises a single point. This may also be considered as a single point from a more complex scene because scene points may be rendered independently (as noted above). Considering only single points in a scene is a simplification that avoids the need to simultaneously account for the effects of all the scene points; however, it does not affect the generality of the conclusions. At other times the description considers a planar scene, that is a scene in which all the scene points lie on a plane at a fixed distance from the plane of the lightfield display. They might represent a flat image, such as presented on a known 2D television, or they might represent the backdrop to a scene, perhaps even “at infinity”. These special cases are used to simplify the explanation of the disclosure but do not limit its generality.

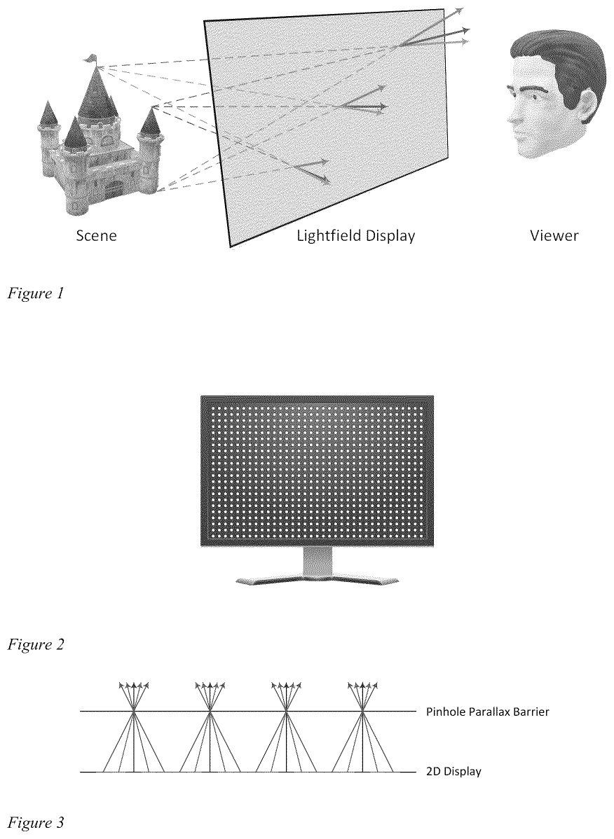

A simple example of a lightfield display uses a pinhole array, or “parallax barrier”, to control the angle of light rays from points on the display. A parallax barrier lightfield display may be thought of as an array of pinholes in front of a 2D display, as illustrated in FIG. 2. Behind each pinhole is an array of elementary pixels which form an image. This image is the same as would be captured by a pinhole camera in a corresponding position relative to the scene. The 2D display is divided into juxtaposed regions, one per pinhole, corresponding to these images. Each pinhole together with the respective array of elementary pixels constitutes a holographic element or “hogel”.

Behind each pinhole is a 2D array of pixels for displaying an image. Each pixel (together with the corresponding pinhole) generates a light ray in one direction. The direction of the ray is defined by the geometry of the pinhole and the pixel in the 2D display. This is illustrated, in one dimension only, in FIG. 3. Many explanations herein are presented in terms of a 1 dimensional display for simplicity. In practice displays would be 2-dimensional so that these 1 dimensional descriptions would be extended to 2 dimensions, as will be apparent to a person skilled in the art.

An example image of a 3D scene is shown in FIG. 4 (from Synthetic Light Field Archive at web.media.mit.edu/^{˜}gordonw/SyntheticLightFields/index.php).

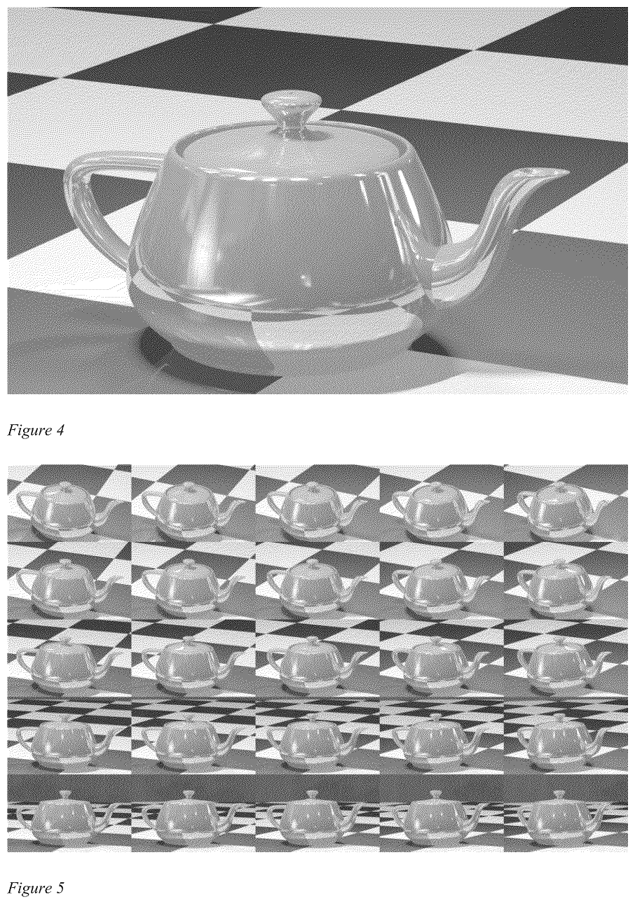

Behind each pinhole in the display there would be a small elementary image, each one from a slightly different perspective (as illustrated in FIG. 5).

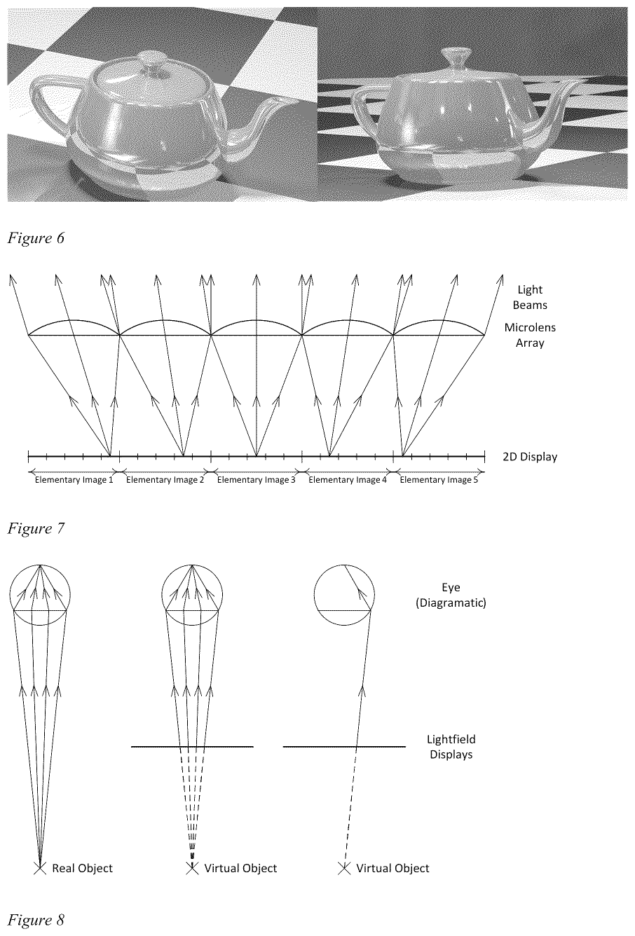

The mosaic of images in FIG. 5 corresponds to a display with only 5×5 pinholes and is shown for illustrative purposes only. In practice, there would be many more pinholes and elementary images. Note that each image on the display would be reversed (flipped both horizontally and vertically or, equivalently, rotated by 180°); however, this figure serves to illustrate the principle without unnecessary detail. Note also that each of the elementary images is from a different perspective, or parallax. For example, the image at the top left of the array is from a perspective above and to the left of the image in bottom right, as shown enlarged in FIG. 6.

To avoid confusion, it is useful to define some terminology. With a 2D display we have a 2D array of samples known as pixels (short for picture elements). In a lightfield display an array of 2D pixels are arranged to represent a 4-dimensional, lightfield, signal. The terminology used herein refers to the set of pixels behind each pinhole, together with the pinhole itself, as a “hogel”, short for holographic element. The hogel position, corresponding to one specific elementary image, represents two dimensions of the signal (horizontal and vertical position). The coordinates of a pixel within a hogel represent a further two dimensions, which are the angles from the display normal (horizontal and vertical) at which rays or beams are emitted from the hogel.

Unfortunately, pinhole array lightfield displays are very dim. For the pinhole to accurately define the direction of a light ray it must be very small. Almost all of the light emitted by the 2D display is blocked by the pinhole array, making the 3D image very dim. In practice the pinholes may be replaced by microlenses focused on the elementary images, which avoids the loss of light.

A lightfield display using microlenses (instead of the pinholes used in the example of FIG. 3) is illustrated (in one dimension only) in FIG. 7. An actual display comprises a 2D array of microlenses, one per hogel, in front of a high resolution known 2D display. The microlenses are placed at their focal distance in front of the elementary images, so that the microlenses span a number of pixels on the 2D display (five in this example). Light emitted from a pixel generates a parallel beam in the same direction as the ray that would be produced by using a pinhole parallax barrier. Now, however, rays emanating at a range of angles from the pixel, not just a single ray, form a parallel beam. Consequently, the image is much brighter. FIG. 7 shows pixels in different hogels generating beams at different angles. Each hogel generates a full set of angled beams, one for each of its pixels, not just a single beam, but most beams are elided for clarity in FIG. 7. So, the use of a microlens for each hogel, rather than a pinhole, results in a much brighter image. Known lightfield displays typically implement this arrangement using a “microlens array” in front of a high resolution 2D display.

The most significant problem with known lightfield displays is the angular resolution needed to generate a large depth of field. The angular separation between distinct rays, or beams, produced by adjacent pixels is referred to as the angular resolution. The display must also provide adequate spatial resolution, as well as adequate angular resolution.

In order to understand the extent of the problem, it is helpful to estimate the number of pixels required to achieve an infinite depth of field. That is, the resolution that the underlying 2D display would require to implement such a lightfield display. Two extreme cases should be considered, first where the lightfield display emulates a known 2D display (i.e. it presents a planar image coincident with the display), and second where the lightfield display presents an image “at infinity”. The former allows us to determine the number of hogels needed, whilst the latter determines the number of pixels required.

With a known 2D display the picture, ideally, looks the same from every viewing angle. So, the luminance of light rays from a pixel on a 2D display should be independent of the viewing angle. Hence, in order to emulate a known 2D display using a lightfield display, the luminance of rays from a hogel should also be the same in every direction. Therefore, all the pixels behind a hogel should have the same luminance. That is, each elementary image is simply a patch of constant luminance, corresponding to a single pixel in the emulated 2D image. Were one to look at the underlying (2D) display within a lightfield display whilst it was emulating a 2D display, it would simply look like the flat picture it was emulating. Consequently, in order to present an image with a desired resolution, coincident with the display, the number of hogels must equal the number of pixels. For example, 1920 hogels would be required across the width of a display for its spatial resolution to correspond to conventional HD TV resolution (1920 pixels, as specified in ITU-R Recommendation BT.709).

A lightfield display should also be able to generate an image in the far distance, that is, “at infinity”. Elementary optics determines that a flat image placed at the focal point of a lens produces a virtual image at infinity. To emulate this using a lightfield display, each elementary image must be a miniature version of the desired image at infinity. Consequently, in order to present an image at infinity, the number of pixels must equal the number of pixels in the equivalent 2D image. For example, an HD display would require (horizontal rows of) 1920 pixels.

It is informative to contrast a lightfield display presenting a 2D image coincident with the display and presenting an image at infinity. In the former case all the rays from each hogel (i.e. at the same spatial location) have the same intensity, but the intensity varies with position. When presenting an image at infinity, all the rays emanating in each direction, from anywhere on the display, have the same intensity, but the intensity varies with angle. To put this another way, in order to display a 2D image coincident with the display, only one pixel per hogel is required, but many hogels are needed. Whereas, to display an image at infinity, only one hogel is needed but many pixels per hogel are required.

To present images both at infinity and coincident with the display, a lightfield display requires both the number of hogels, and the number of pixels per hogel, to equal the number of pixels on a known 2D display. Therefore, the number of pixels required grows as the fourth power of the image resolution. This quickly requires an impracticably large resolution from the underlying 2D display. A conventional 2D high definition (HD) display has 1920 pixels horizontally. Hence an HD lightfield display would require a total of nearly 4 million pixels horizontally. Currently, the highest available resolution for television displays and computer monitors is 8 k (7680) pixels horizontally; so an implausibly large increase in resolution is required to implement high quality lightfield displays.

The number of hogels, and the number of pixels per hogel, required to present an image varies with the depth of that image. For an image coincident with the display many hogels are required, but only a single pixel per hogel. Conversely to present an image at infinity many pixels are needed per hogel, but only one hogel. The Borer article, in its equation 14, provides formulae to calculate the number of hogels and pixels that are needed for an image at any depth, which are used subsequently. In practice the depth of field presented by a lightfield display is limited by the number of pixels in its underlying 2D display.

Equation 1a gives the maximum spatial separation between hogels (denoted xₛ), for example in mm. Equation 1b gives the maximum angular separation between light beams (denoted us), for example in degrees or radians. These separations (or “sampling periods” in signal processing terminology) depend on the ratio of the image depth behind the display (denoted d) to the viewing distance (i.e. the distance of the viewer from the display, denoted v). The hogel separation is calculated relative to the separation at zero depth (denoted x0), i.e. for the case of a 2D image coincident with the display. For example, x0 might be 0.65 mm for an HD resolution, 55″, display (see below). The beam separation is relative to the separation for an image at infinity (denoted u∞), which is inversely proportional to the number of pixels. If the maximum separation between hogels is small, then a lot of them are needed across the width of a display. This is the case of an image coincident with the display. Conversely if the maximum separation of pixels is large then few hogels are needed across the entire display; this is the case of an image at large depth or at infinity. Similarly, a large beam separation corresponds to images coincident with the display and small separations to images at large depths.

$${x}_{s} = {x}_{0} \cdot ( 1 + \frac{d}{v} ) \qquad Equation 1 ( a )$$

$${u}_{s} = {u}_{∞} \cdot ( 1 + \frac{v}{d} ) \qquad Equation 1 ( b )$$

Equations 1(a) and 1(b) are introduced to aid the description below. Actually, only equation 1(b) separation is required below. It is easier to understand the relationship between the depth of an image and the number of pixels required, by restructuring equation 1(b) to give:

$${N}_{e} = \frac{{N}_{∞}}{( 1 + \frac{v}{d} )} \qquad Equation 2$$

Here Nₑ is the number of pixels per hogel required for an image at depth d, compared to the number, N_{∞}, required for an image at infinity. For an image at infinity equation 2 gives Nₑ=N_{∞}, as expected. When the image is at the same distance behind the display as the viewer is in front, i.e. when d=v, it yields Nₑ=(N_{∞}/2). And when for images coincident with the display, i.e. d=0, the formulae gives Nₑ=0 (though, in practice, you can't have less than one pixel per hogel in a lightfield display).

In summary, the angular resolution of a known lightfield display is limited by the number of pixels within its hogels. Even with the highest resolution 2D displays currently available there are insufficient pixels available to produce more than a few centimeters depth of field behind, and in front, of a 3D display. Although display resolutions are increasing rapidly, it is unlikely that adequate resolution will be achieved in the foreseeable future.

The present disclosure provides a lightfield display for generating a 3D image. The lightfield display comprises a 2D array of hogels. Each hogel comprises a 2D array of one or more pixels for generating light rays, and a light distribution control arrangement for controlling in 2D the angular distribution of the light rays from the array which are emitted by the hogel. The 2D array of each hogel is arranged to generate light rays which correspond to an elementary image assigned to the hogel, with each elementary image having a central axis which passes through the center of the image and extends perpendicular to the image. A plurality of the hogels have different lateral offsets between their light distribution control arrangement and the central axis of the respective elementary image.

For a known lightfield display to render an image “at infinity” the number of pixels within each hogel must at least equal the number of hogels in the display. So, the total number of pixels increases as the fourth power of the display resolution. As the display resolution increases the total number of pixels rapidly becomes impractical. For example, a lightfield display with HD resolution would require (1920×1080)2=4,299,816,960,000 pixels in all. Not only is this far beyond the resolution of current displays, but it would also require a “typical”, 55″, television to have pixel sizes that are smaller than the wavelength of light. Clearly if lightfield displays are to be practical they must be able to operate with many fewer pixels.

It is an aim of this disclosure to enable lightfield displays to achieve large angular resolutions, and hence large depths of field, with many fewer pixels.

The inventor has realized that not all the light beams generated by existing lightfield displays are required. For a known 2D display the eye focuses on the display and gathers light from, typically, a single pixel for each point on the retina. Lightfield displays are different. For images behind and in front of the display the eye gathers light from a multiplicity of hogels for each point on the retina. Furthermore, the eye gathers light from an increasing number of hogels as the image gets further from the display surface. Since not all these light beams are actually required, the number of pixels may be reduced by distributing their generation over multiple neighboring hogels. Distributing the generation of light beams across multiple hogels can be accomplished through a technique of angular subsampling. For a fixed number total number of pixels, i.e. for a given underlying 2D display resolution, angular subsampling allows a significant increase in the depth of field. In a design example it is shown that a known lightfield display, suitable for a mobile phone, could achieve a depth of field of 1.174 cm, whereas, by using 4:1 angular subsampling, this is increased to 8.85 cm.

Existing lightfield display configurations would require an impracticably large number of impracticably small pixels to achieve a large depth of field. The technique of angular subsampling substantially reduces the number of pixels that are required, enabling the implementation of a lightfield display with an increased depth of field for a given number of pixels.

In one example, the intensities of the light rays from each of the pixels of the plurality of hogels are interpolated intensities corresponding to the respective lateral offset. The interpolated intensities may be determined by applying angular subsampling to an elementary image assigned to a given hogel and then interpolating the intensities in accordance with the respective lateral offset.

Accordingly, a lateral offset between an elementary image and the associated light distribution control arrangement may be achieved by interpolating intensities for the pixels of the hogel which correspond to a lateral shift of the elementary image assigned to the hogel.

The lightfield display may include a display driver coupled to the hogels for generating signals to control emission of light rays from the hogels. The display driver may be configured to control the plurality of the hogels such that each of the plurality of hogels generates first light rays corresponding to a first set of respective lateral offsets in a first display frame, and generates second light rays corresponding to a second set of respective lateral offsets different to its first set of lateral offsets in a second display frame, with the first and second display frames contributing to forming the same 3D image visible from the same position relative to the display.

In some implementations, each hogel is arranged to generate light rays at a set of ray angles relative to a central axis of its array of pixels and a plurality of the hogels are arranged to generate different sets of ray angles to each other.

The different sets of ray angles generated by the hogels of the display are selected so that the resulting light rays combine in the same display frame to form the desired image. The image may be visible to the human eye or to a camera.

The sets of ray angles associated with each of the plurality of hogels may have one or more (but not all) ray angles that are the same. In some examples, the sets of ray angles associated with each of the plurality of hogels are entirely different.

In some examples, the set of ray angles of each of the plurality of hogels is different to the sets of ray angles of a plurality (or all) of their adjacent hogels. In some examples, the set of ray angles of each of all (or substantially all) of the hogels of the display is different to the sets of ray angles of all of their adjacent hogels.

Each hogel includes a 2D array of one pixel or more than one pixel. That is, it may include a single pixel. It may include an M×M or M×N 2D array of pixels, with M and N greater than or equal to 1. The or each pixel of a hogel may be in the form of a unidirectional pixel. It may comprise a laser diode pixel for example.

The light distribution arrangement may dictate the angular orientation of the or each pixel of the respective hogel, and therefore the angle of the corresponding light rays.

If a hogel includes a single pixel, it may generate light rays at a set of ray angles with the set consisting of a single ray angle.

The central axis of each array of pixels may extend through the center of the array and perpendicular to the plane of the array.

Each hogel may generate a set of light rays which corresponds to a different elementary 2D image.

The hogels of the display may lie in a planar or curved display plane or surface. The lateral offsets of the plurality of hogels between their light distribution control arrangement and the central axis of the respective elementary image may be in a direction parallel (or tangential) to or along the display plane (or surface).

The light distribution control arrangement may control in 2D the angular distribution of the light rays it receives from the pixels.

A plurality of the light distribution control arrangements may be operable to change the angular distribution of the light rays from the pixels which are emitted by the respective hogel. This may facilitate spatiotemporal angular subsampling. The angular distribution of light rays emitted by a hogel may vary over a sequence of display frames.

A display may be required to present 2D, as well as 3D, images. For example, a mobile phone may require a 3D display for some apps, such as games or video conferencing, it may also require a 2D display for more conventional apps. A reduction in resolution may be acceptable to achieve a 3D display, but not when presenting 2D images. The hogel spacing in a known lightfield display determines the resolution of the 2D images that it can present. However, reducing the hogel spacing results in fewer pixels per hogel, which limits the 3D depth of field. Thus, with a known lightfield display, there is a trade-off between 2D resolution and 3D depth of field. With angular subsampling, the technique of spatial oversampling may be used to increase the resolution of 2D images that can be displayed, without reducing the depth of field of the 3D display. This is possible because, as the hogel spacing decreases, increasing the 2D resolution, the number of hogels from which the eye gathers light increases proportionately. Hence the subsampling factor may increase to compensate for the reduction in the number of elementary pixels due to reduced hogel spacing. Angular subsampling, which may preferably be combined with spatial oversampling, allows a lightfield display to present high resolution 2D images without compromising the depth of field for 3D images.

A lightfield display according to the present disclosure may be configured to display a single, static 3D image only. Alternatively, displays according to examples of the present disclosure may present different 3D images at different times, for example to give a moving image. The lightfield display may include a display driver coupled to the hogels for generating signals to control emission of light rays from the hogels.

The pixels may be provided in various forms, for example by an LCD, a light emitting diode (LED) display, an organic light emitting diode (OLED) display, a plasma display or a cathode ray tube (CRT) display.

A fixed, static 3D image could be generated using arrays of unchanging pixels. Such an array could be provided without requiring a driven matrix of individually controllable pixels. For example, this could be implemented by means of a fixed array of light sources, such as a fixed, perhaps printed, pattern of colored filters together with rear illumination.

The inventor also recognized that light beams do not have to be present at all times due to the persistence of vision. Consequently, the generation of light beams may be distributed over time. Distributing the generation of light beams over time can be accomplished through a technique of temporal subsampling.

The display driver may be configured to control the plurality of the hogels such that each of the plurality of hogels generates first light rays at a respective first subset of its set of ray angles relative to a central axis of its array of pixels in a first display frame, and to change the direction of the light rays from the hogels with the light distribution control arrangement to generate second light rays at a respective second subset of its set of ray angles different to its first subset of ray angles relative to the central axis of its array of pixels in a second display frame, with the first and second light rays contributing to forming the same 3D image visible from the same position relative to the display.

Thus, the two techniques of spatial and temporal angular subsampling may be used together as spatiotemporal subsampling. Doing so allows the generation of light beams to be distributed both over neighboring hogels but also across consecutive frames in a changing image.

The plurality of hogels may have different lateral offsets between their light distribution control arrangement and the central axis of the respective array of pixels. This may be implemented by evenly distributing their light distribution control arrangements, with each array of pixels having a different lateral offset relative to the respective light distribution control arrangement. In other implementations, the arrays of pixels may be evenly distributed, with the respective light distribution control arrangements having different lateral offsets relative thereto.

The light distribution control arrangement of each hogel may comprise a parallax barrier which defines an aperture (or pinhole), with the respective array of pixels located relative to the aperture such that light rays generated by each of the pixels of the array pass through the respective aperture.

The apertures associated with the plurality of hogels may have different lateral offsets relative to the respective central axes of their arrays of pixels.

The light distribution control arrangement may be operable to adjust the lateral offset of the aperture of each of the plurality of hogels. For example, the light distribution control arrangement may be operable to mechanically adjust the lateral offset of the aperture of each of the plurality of hogels.

In some examples, each parallax barrier is formed by an LCD and the light distribution control arrangement is operable to adjust the lateral offset of the aperture of each of the plurality of hogels by controlling the LCD to move each parallax barrier.

The light distribution control arrangement of each hogel may comprise a focusing optical arrangement, and each focusing optical arrangement may be spaced from the respective array by its focal distance.

Each focusing optical arrangement has a central optical axis, and the central optical axes of the focusing optical arrangements associated with the plurality of hogels preferably have different lateral offsets relative to the central axis of the respective array of pixels.

The light distribution control arrangement may be operable to adjust the lateral offset of each of the focusing optical arrangements. For example, the light distribution control arrangement may be operable to mechanically adjust the lateral offset of each of the focusing optical arrangements.

The light distribution control arrangement of each hogel may include an offsetting optical arrangement for changing the direction of light rays emanating from the respective hogel. Each offsetting optical arrangement may be controllable to alter the magnitude of the change it makes to the direction of light rays incident on the offsetting optical arrangement.

For example, each offsetting optical arrangement may comprise an offsetting prism. The offsetting prism may include liquid crystals and be controllable to vary its offset to implement spatiotemporal subsampling.

In some examples, the sets of light rays are allocated to the plurality of hogels so as to interleave and to substantially evenly space apart the angles of the light rays emanating from adjacent hogels. The angular spacing between the light rays emanating from adjacent hogels may be maximized in the allocation of the sets of light rays to the hogels.

Allocation of sets of light rays to adjacent hogels so as to result in a relatively even spread of ray angles when one set of ray angles is superimposed on the other tends to improve the quality of the resulting image, and may avoid any patterning effects.

The 2D array of hogels may comprise a plurality of groups of hogels, with the hogels of each group arranged to have different lateral offsets between their light distribution control arrangement and the central axis of the respective elementary image, and each group arranged to generate the same combination of lateral offsets.

The 2D array of hogels may comprise a plurality of groups of hogels, with the hogels of each group arranged to generate different sets of ray angles to each other. Each group may be arranged to generate the same combination of ray angles.

Each group of hogels may in combination emit rays at a greater number of ray angles than are emitted by each individual hogel of the group.

Different subsampling ratios may be required to render images at different depths. According to the present disclosure, permuting the subsampling phases may enable a display with a single fixed subsampling ratio to generate accurate images at a wider range of depths.

There are many ways to generate good permutations of the subsampling phases. A good permutation is one in which the subsampling phase in adjacent hogels differs as much as possible.

The 2D array of hogels may comprise a plurality of groups of hogels, with the hogels of each group arranged to generate different sets of ray angles to each other in each of a plurality of display frames, and each group arranged to generate the same combination of ray angles over the plurality of display frames.

For example, each group may be arranged in a 2×2 array.

Each hogel of each group of hogels may define a respective lateral offset (of an aperture, focusing optical arrangement, offsetting optical arrangement, pixel array or interpolated elementary image, for example), with the lateral offsets of the group of hogels forming an incremental sequence.

In one example of spatiotemporal subsampling, each hogel of each group of hogels defines a respective lateral offset in each of a plurality of display frames and the lateral offsets of the group of hogels in the plurality of display frames form an incremental sequence.

The lateral offsets of one of the groups may be ordered differently in the display to the lateral offsets of another of the groups. Different orders of lateral offsets may be used in the groups in a sequence in the display or arranged randomly.

The lateral offsets of the group maybe ordered in the display by numbering each offset of the sequence in turn in binary, bit reversing the binary numbers, and then arranging the hogels of the group with reference to the sequence of the bit reversed binary numbers.

In one dimension a good permutation may be generated by bit reversing linear phase order. In a lightfield display angular subsampling is applied in two dimensions, both horizontally and vertically, requiring a 2-dimensional subsampling phase. The 2-dimensional phase may be permuted separately, horizontally and vertically, by bit reversal.

In a further implementation, the lateral offsets of the group may be ordered in the display by numbering each offset in turn in binary by scanning the group using a space filling curve, bit reversing the binary numbers to form a revised sequence, scanning the revised sequence using a space filling curve and then arranging the hogels of the group with reference to the sequence of the scanned revised sequence.

It may be preferable to scan the 2-dimensional array of subsampling phases using a space filling curve, such as a Hilbert curve. This produces a list of subsampling phases that can then be permuted using bit reversal. The bit reversed list may then be rescanned back to two dimensions using a second space filling curve.

As with spatial angular subsampling, a good permutation of subsampling phases must be chosen to enable 3D images to be rendered properly at all depths. A good permutation may be generated separately in all three dimensions, by bit reversing linear phase order. Preferably, a good permutation may be generated by scanning the linearly ordered 3D array of subsampling phases using a space filling curve, permuting the order of the list that is generated using bit reversal, and regenerating a 3D array of phases by rescanning using another space filling curve. In an enhanced design example it is shown that, whereas a known lightfield display, suitable for a mobile phone, could achieve a depth of field of 1.74 cm, by using 4:1 angular subsampling combined with 4:1 temporal angular subsampling, this would be increased to 27.78 cm.

In other examples, the sets of light rays may be allocated randomly (or pseudorandomly) to the plurality of hogels.

Each array of pixels may include pixels which generate light rays of different colors to each other.

According to further examples described herein, lightfield displays may display colored images. This can be achieved by splitting elementary pixels into independently controllable, colored areas, as is done for known 2D displays.

Each hogel may generate light rays of a single color only. Neighboring hogels may produce different primary colors, for example. If each hogel only generates a single color, this allows a greater number of elementary pixels (and therefore a greater depth of field), because the elementary pixels do not have to be sub-divided. It is advantageous that color dispersion in the optics is reduced when generating beams of a single color.

Single color hogels may be particularly advantageous for spatially oversampled displays because the eye will then gather beams from multiple adjacent hogels. Hence the colors generated by adjacent hogels will be combined in the eye to form a full color image. A four-color display would be particularly suitable because it easily accommodates binary subsampling ratios.

Each hogel may include a color filter arranged so that the light rays emanating from the hogel have passed through the color filter. Alternatively, the pixels of each array of pixels generate the same color as each other.

The present disclosure provides a method of controlling a lightfield display as disclosed herein, the method comprising generating light rays with the 2D array of each hogel which correspond to an elementary image assigned to the hogel, wherein a plurality of the hogels have different lateral offsets between their light distribution control arrangement and the central axis of the respective elementary image.

The method may comprise generating first light rays corresponding to a first set of respective lateral offsets in a first display frame, and generating second light rays corresponding to a second set of respective lateral offsets different to its first set of lateral offsets in a second display frame, with the first and second display frames contributing to forming the same 3D image visible from the same position relative to the display.

The present disclosure also provides a method of controlling a lightfield display as disclosed herein, the method comprising controlling in 2D the angular distribution of the light rays from the array which are emitted by the hogel, wherein each hogel is arranged to generate light rays at a set of ray angles relative to a central axis of its array of pixels and a plurality of the hogels are arranged to generate different sets of ray angles to each other to form the 3D image.

Furthermore, the present disclosure provides a method of controlling a lightfield display as described herein, comprising controlling a plurality of the hogels such that each of the plurality of hogels generates first light rays at a respective first set of ray angles relative to a central axis of its array of pixels in a first display frame, and to change the direction of the light rays from the hogels with the light distribution control arrangement to generate second light rays at a respective second set of ray angles different to its first set of ray angles relative to the central axis of its array of pixels in a second display frame, with the first and second light rays contributing to forming the same 3D image at the same position relative to the display.

### Spatial Angular Subsampling

A key problem in implementing lightfield displays is the extremely large number of elementary pixels needed to achieve an adequate spatial resolution and depth of field. An aim of this disclosure is to significantly reduce the number of elementary pixels required to achieve both adequate spatial resolution and depth of field. A technique elucidated herein to achieve this, “angular subsampling”, may be implemented spatially, temporally, or both. Angular subsampling may be used, inter alia, with both parallax barrier and microlens array lightfield displays. This section describes the technique of spatial angular subsampling, which is referred to simply as “angular subsampling”, until temporal angular subsampling is introduced in a subsequent section.

The rationale for spatial angular subsampling is the way the human eye, or indeed a camera lens, captures images. When the eye (or camera) focuses on a point on the surface of an object, it captures light rays reflected or emitted from that point over a range of angles. This is illustrated in the left-hand part of FIG. 8. Multiple rays from a point on an object are focused at a single point on the retina and form one point in the image seen by the eye. A lightfield display seeks to generate an image of the object as illustrated in FIG. 1. The center part of FIG. 8 introduces a lightfield display between the virtual point object and the eye. Now, instead of all the light rays emanating from a single point on a real object, they are generated over a region (area in 2D) of the lightfield display. This disclosure recognizes that, once the rays, focused from a point on an object, hit the retina, all the information about how many rays, their individual intensity, and their angle of incidence at the eye is lost. This means that the lightfield display does not need to reproduce all the rays that would emanate from a point on a virtual object. A single ray from the virtual object, provided it is generated at the correct angle and position on the lightfield display, can evoke the same response as the complete set of rays. This is illustrated in the right-hand part of FIG. 8. With a real object, or an existing lightfield display, the light receptor in the retina (e.g. a cone cell) adds (or integrates) the luminous intensity from all the rays it captures to produce its output signal. So, one caveat to producing only a single ray is that its intensity should preferably be the sum of the intensities of the full set of rays had they all been generated. If the display only generates a single ray for a point on a virtual object, that ray must be more intense (“brighter”) to evoke the same response from the retinal light receptor (or camera sensor).

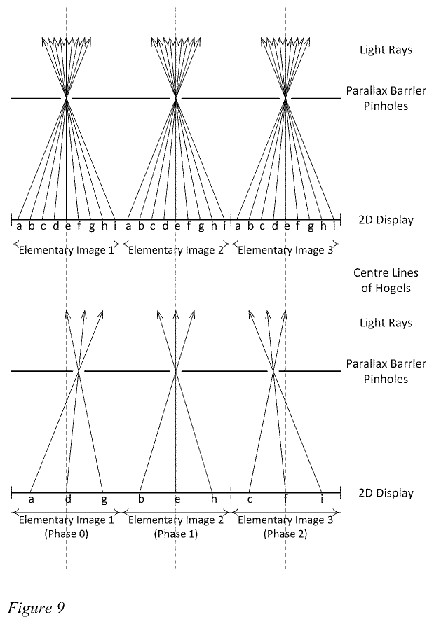

Recognizing that a lightfield display does not need to generate all the rays from a virtual object allows each hogel to produce a smaller number of rays. Implemented correctly, fewer rays per hogel need not result in a reduced depth of field. FIG. 9 illustrates how this may be done assuming, for simplicity, a pinhole array display (alternative implementations are described below). FIG. 9a (top) illustrates 3 hogels in a known pinhole lightfield display (in 1 dimension). Each hogel includes 9 elementary pixels in its elementary image, so each hogel generates 9 rays (labelled a to i). FIG. 9b shows 3 hogels providing an equivalent display by applying a factor of 3 angular subsampling. In FIG. 9b (bottom) each hogel only has 3 elementary pixels and therefore only generates 3 rays. However, in FIG. 9b the rays have a different angular offset for each hogel. The central hogel has zero angular offset and so generates rays corresponding to rays b, e, and h in the central hogel of FIG. 9a. The left hand hogel of FIG. 9b has a negative (clockwise) angular offset corresponding to the difference in ray angles in FIG. 9a. Consequently, it generates rays corresponding to rays a, d, and g. Similarly, the right hand hogel in FIG. 9b has a positive (counterclockwise) angular offset, and it generates rays corresponding to rays c, f, & i in FIG. 9a.

In the example of FIG. 9b (3:1 angular subsampling), the central hogel produces a set of rays with subsampled angles. The adjacent hogels also produce subsampled sets of rays, but with interleaving angles. The 3 subsampled hogels between them produce the full set of ray angles. Since a ray, at a given angle, is only needed from one of these hogels, the eye (or camera) will see an image no different to that from a hogel emitting the full set of rays. By subsampling the set of angles produced by each hogel, we can evoke the same response in the viewer (or camera), using fewer elementary pixels overall, and still generate the same depth of field from the display. Implementing 3:1 angular subsampling therefore reduces the total number of elementary pixels required by a factor of 3.

The intensities of the rays, in FIG. 9b, are intended be the same as those generated by the hogel in the same position in FIG. 9a. So, ray e in FIG. 9b is intended to be the same intensity as ray e in the central hogel of FIG. 9a, whereas ray d in FIG. 9b is intended to be the same intensity as ray d in the left hand hogel of FIG. 9a. This is a preferred implementation of this disclosure. It ensures that the intensity of rays corresponds to their correct spatial location.

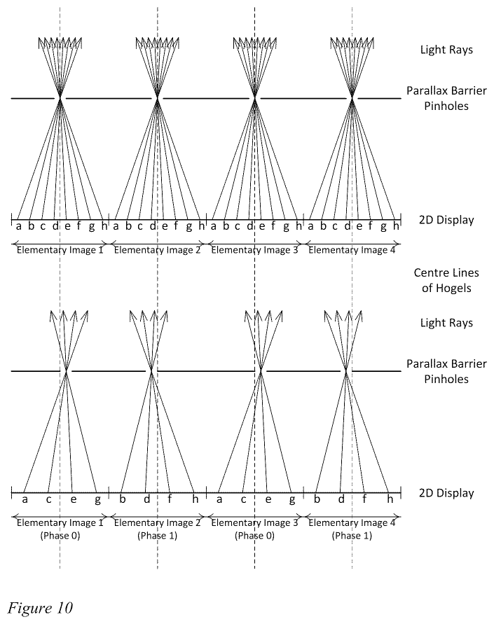

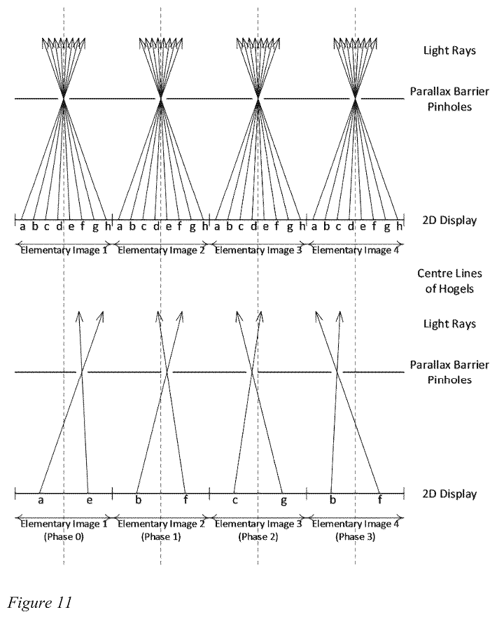

FIGS. 10 and 11 illustrate angular subsampling, by factors of 2 and 4 respectively. With the necessary changes and with due alteration of details it is similarly possible to implement angular subsampling by any factor and with any number of elementary pixels per hogel.

FIGS. 9b, 10b, and 11b also illustrate one way that angular subsampling may be implemented. In these examples the angular offsets are produced by adjusting (modulating) the position of the pinhole relative to the central axis of the hogel. Normally the pinhole is placed centrally within the hogel, i.e. immediately above the center of the elementary image. Repositioning the pinhole results in the angle of the rays being offset. In FIG. 9b the rays are offset by −1 (clockwise), 0, and +1 (counterclockwise) angular sampling periods respectively. The angular sampling period is the separation of the rays in FIG. 9a (i.e. without angular subsampling). The negative angular offset, in the left hand hogel of FIG. 9b, is achieved by moving the pinhole the width of an elementary pixel in FIG. 9a (i.e. an un subsampled elementary pixel) to the right. Similarly, the positive offset in the right hand hogel requires shifting the pinhole the width of one (un subsampled) elementary pixel to the left. In FIG. 10b, by contrast, the hogel rays are offset by −½ and +½ angular sampling periods. That is, the pinholes are displaced ½ the width of an un subsampled elementary pixel (FIG. 10a) to the right and to the left. Correspondingly, in FIG. 11b, the hogel rays are offset by −1½, −½, +½, +1½ angular sampling periods by displacing the pinholes ½ and 1½ un subsampled elementary pixel widths (FIG. 11a) to both the right and the left.

The displacements of the pinholes, relative to the center of the hogel, in FIGS. 9b, 10b, and 11b, correspond to subsampling “phases”, which are considered in more detail below. The 3:1 subsampling illustrated in FIG. 9 has 3 subsampling phases, corresponding to angular offsets −1, 0, and +1 described above. Similarly, 2:1 subsampling in FIG. 10 has 2 subsampling phases corresponding to angular offsets −½, and +½. And 4:1 subsampling in FIG. 11 has 4 subsampling phases corresponding to angular offsets −1½, −½, +½, and +1½. In general, a subsampling factor of n (n:1 subsampling) will have n subsampling phases.

The difference between angular offsets is, in general, one angular sampling period. The angular offsets in FIG. 10b are illustrated as −½, and +½ for symmetry, which would be a preferred implementation. However, they could equally well be, for example, −½ and +%, or any other phases that have a separation of one angular sampling period.

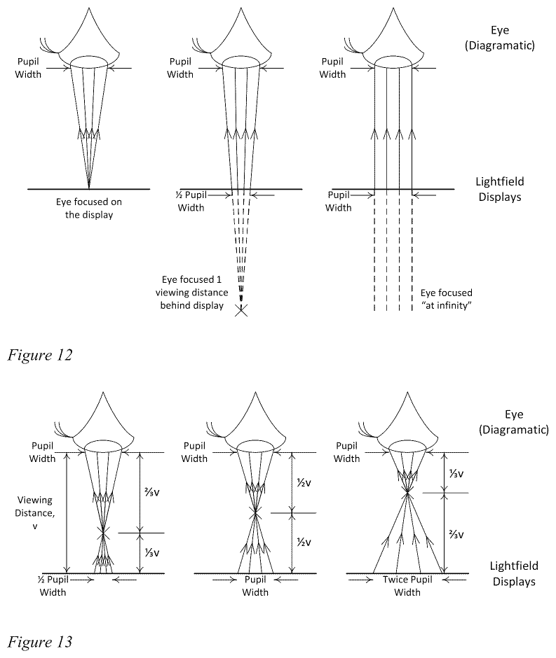

The effectiveness of angular subsampling depends on the subsampling factor, so it is necessary to determine an appropriate value for this factor. When a display presents an image coincident with its surface, the eye will focus on the display surface. In this case (FIG. 12a) all the rays captured by the eye emanate from a single point on the display (i.e. from a single hogel). In this case no angular subsampling is possible. If, instead, the eye is focused on a virtual image rendered one viewing distance, v, behind the display (FIG. 12b), then it captures rays emanating from a region half the width of the aperture of the eye (i.e. half the diameter of the eye's pupil). And if the eye is focused at infinity (FIG. 12c) then it captures rays emanating over a region the full width of the aperture of the eye (i.e. the whole diameter of the eye's pupil).

The situation for real images in front of the display is similar, as illustrated in FIG. 13. For an image rendered ⅓ of the viewing distance in front of the display (FIG. 13a) the emanating region is half the diameter of the pupil. An image rendered halfway between display and viewer (FIG. 13b) has an emanating region equal to the diameter of the pupil. And when the image is rendered ⅔ of the viewing distance in front of the display (FIG. 13c) the emanating region is twice the diameter of the pupil. Clearly the size of the emanating region depends on the distance from the display at which the image of an object is rendered.

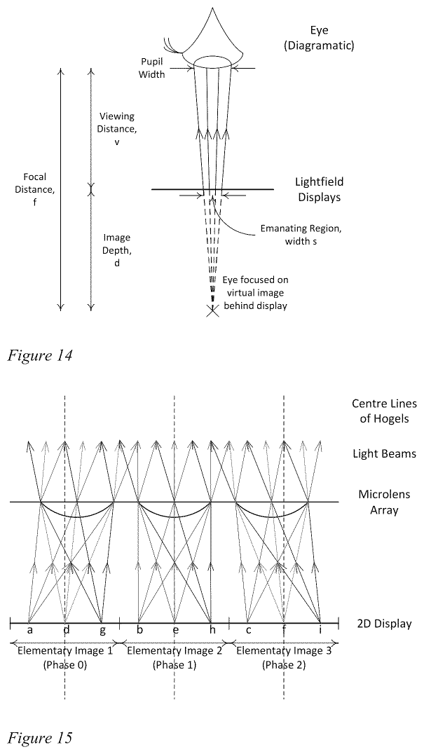

The width, s, of the emanating region of the display, may be calculated given the distance, f, at which the eye is focused. FIG. 14 shows the geometry determining the size of the emanating region, from which;

$$s = p \cdot \vert 1 - \frac{v}{f} \vert \qquad Equation 3$$

where p is the diameter of the eye's pupil. The modulus is because, for real images in front of the display, s would otherwise be negative, and we require a positive result.

Equation 3 produces the curious result, that s=0, when the eye is focused precisely at the surface of the display (i.e. when f=v). This is because FIG. 14, and therefore equation 3, assumes that the eye can actually focus at a single point (with zero size). In reality the eye gathers light over a small range of angles determined by its angular visual acuity (typically 1 minute of arc). This spread of angles is known as the point spread function of the eye, denoted psf. To find the true size of the emanating region we must take account of the point spread function. Hence a more accurate formula for the size of the emanating region is given by:

$$s = p \cdot \vert 1 - \frac{v}{f} \vert + psf \qquad Equation 4$$

It is more convenient to express this in terms of the distance from the display surface, d, at which an object is rendered (and therefore at which the eye is focused). The distance d is positive when rendering virtual images behind the display and is negative when rendering real images in front of the display. Noting that f=v+d, where v is the viewing distance (i.e. the distance of the viewer from the display), the equation becomes:

$$s = p \cdot \vert \frac{1}{1 + ( v / d )} \vert + psf \qquad Equation 5$$

Equation 5 enables the calculation of the factor by which the set of angular rays from each hogel may be subsampled. The eye's aperture, i.e. the diameter of its pupil, must be known. This can vary between about 2 mm and 8 mm. It depends on many factors, most significantly the luminance to which it is adapted. This description assumes a “typical” value for the pupil's diameter of about 4 mm. For example, consider a “typical” viewing scenario of a 55″ diagonal (i.e. about 1.25 m wide) display viewed from about 2.5 m. In this example, and assuming the visual acuity of the eye is 1 minute of arc, the point spread function is about 0.73 mm. With these assumptions the subsampling factor may be calculated by dividing the size of the emanating region by the size of a hogel. For an HD resolution display (1920×1080) the pixel/hogel size is about 0.65 mm. This yields the following angular subsampling factors (as illustrated in FIGS. 12 & 13), where the subsampling factors are rounded to the nearest integer:

TABLE 1
Subsampling factors as a function of the
depth at which an object is rendered

| | (d/v) | | | | | |
|---|---|---|---|---|---|---|
| | ∞ | 1 | 0 | −⅓ | −½ | −⅔ |
| Emanating region, s (mm) | 4 | 2 | 0 | 2 | 4 | 8 |
| subsampling factor | 7 | 4 | 1 | 4 | 7 | 13 |

Table 1 shows that the angular subsampling factor that may be used is substantial, up to 7 or more depending on depth. Perhaps the most important subsampling factor is that for the eye focused at infinity which, for a virtual image behind the display, requires the highest angular sampling rate (i.e. the smallest difference between the angle of rays or beams produced by the display). A factor of 7 for a depth of infinity therefore allows a corresponding reduction in the number of elementary pixels (in both the horizontal and the vertical dimensions). Also noteworthy is that the subsampling factor increases enormously as real images are rendered closer to the eye (i.e. as d tends to −v). This means that rendering real images in front of the display, which is extremely difficult with a known lightfield display, becomes much more achievable using angular subsampling.

### Further Implementations of Angular Subsampling

One implementation of angular subsampling, based on pinhole array lightfield displays, is discussed above. Other implementations are also possible as will be discussed below.

Angular subsampling may be based on known microlens array lightfield displays. The position of the center of the hogel lens may be modulated instead of modulating the position of the pinhole in a parallax barrier display. Angular subsampling by 3:1, using this approach, is illustrated in FIG. 15. FIG. 15 is the microlens display equivalent of FIG. 9b for a pinhole barrier display. The centers of the microlenses, shown here as plano-convex lenses, are displaced by the same amount as the pinholes in FIG. 9b. That is, their centers are displaced −1, 0, and +1, un subsampled elementary pixel widths from the center of the hogel. As with known lightfield displays the advantage of microlenses is that they produce beams of light, rather than single rays, and so produce a much brighter image than a pinhole display.

Previously it was noted that, when angular subsampling is applied, the rays or beams need to be more intense (“brighter”), than without subsampling, to evoke the same response in the eye or camera. For example, with 3:1 subsampling the eye only receives ⅓ of the rays that it would without subsampling. Consequently, each ray needs to be 3 times brighter. However, when applying subsampling, the elementary pixels are bigger than without subsampling. Therefore, with a microlens implementation, which uses almost all the light from the elementary pixels, the beams are automatically brighter with subsampling. Larger elementary pixels provide precisely the increase in beam intensity needed to compensate for subsampling; no other allowance need be made for this effect.

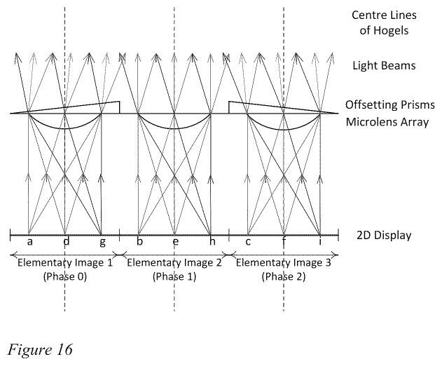

An alternative to spatially modulating the position of a pinhole or the center of the hogel lens is to use a modulating prism. Placing a suitable prism next to a central hogel lens (or pinhole) is equivalent to offsetting the position of the center of the lens (or pinhole). This is illustrated in FIG. 16 for a hogel with a lens; it is analogous to FIGS. 9b and 15. The left hand hogel uses a prism, juxtaposed to the hogel lens, to redirect the beams by one angular sampling period clockwise. The central hogel has no offset. The right hand hogel uses an opposite prism to redirect the beams by one angular sampling period counterclockwise. Note that, in this implementation, all the hogel lenses are positioned centrally within each hogel. The angular offset is determined by the angle of the prism according to the well-known formula δ=(n−1)α, where δ is the offset, n is the refractive index of the prism, and a is prism angle. The prism angle therefore depends on the required angular offset. Generally, an n:1 angular subsampling ratio will require prisms with n different angles, however zero angle prisms (i.e. where no angular offset is needed) may be elided (as in this example).

Modulating prisms may be fixed or variable. Fixed modulating prisms may be implemented as an array of optical elements (prisms), similar to a microlens array. The modulating prisms may, alternatively, be variable. Time varying modulating prisms may be implemented as electrically controllable liquid crystal prisms. Liquid crystals have the property of varying their refractive index (to one orientation of polarized light) in response to an electric field. By varying the electric field along a length of liquid crystal it may be made to emulate the optical properties of a prism. Changing the strength of this electric field effectively changes the angle of the prism and the angle through which the hogel's beams are offset. Such adaptive liquid crystal prisms are known, for example, from C. Chen, M. Cho, Y. Huang and B. Javidi, “Improved Viewing Zones for Projection Type Integral Imaging 3D Display Using Adaptive Liquid Crystal Prism Array,” in Journal of Display Technology, vol. 10, no. 3, pp. 198-203, March 2014. doi: 10.1109/JDT.2013.2293272. Time varying modulating prisms have additional advantages, which are described below.

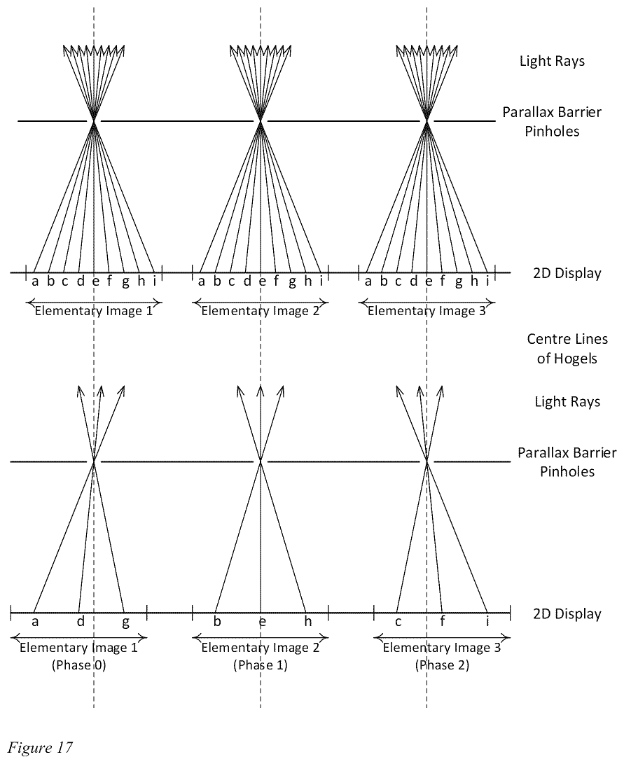

Further implementations of angular subsampling are possible that are similar to FIGS. 9, 10 and 11. In FIGS. 9 to 11, the position of the pinhole in each hogel is offset, or its position is modulated, so that the rays produced are generated with an angular offset. FIG. 17 is analogous to FIG. 9 and part b (bottom) implements 3:1 angular subsampling.

In FIG. 17b, in contrast to FIG. 9b, the pinholes are coincident with the center line of the hogel. Instead of modulating the position of the pinhole the position of the pixel array (and therefore the associated elementary image) is offset instead. Considering any individual hogel, for example the left hand hogel, the relationship between the position of the pinhole and the elementary image is precisely the same as in FIG. 9b. Consequently, the angles of the rays that it produces are also the same. However, to provide space to modulate the position of the elementary image, it is necessary to leave a small space (1 elementary pixel wide in this Fig.) between the hogels.

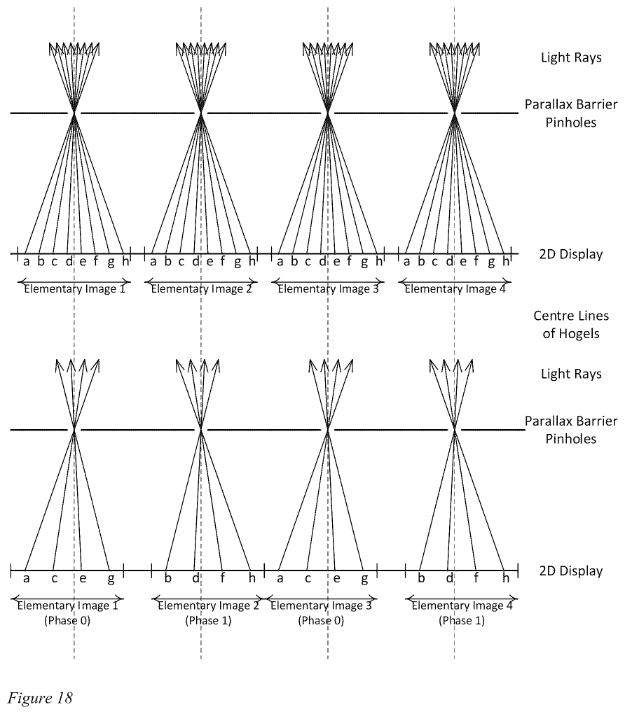

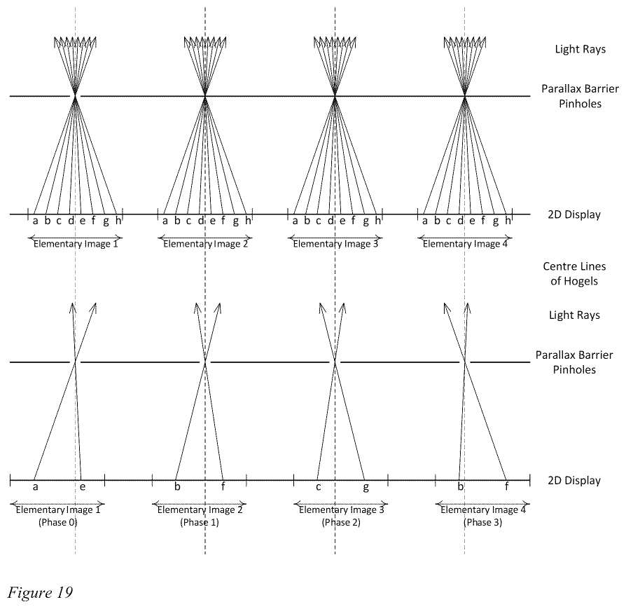

FIGS. 18 and 19 are the same type of implementation, modulating the positions of the elementary images rather than the pinholes, for angular subsampling by factors of 2 and 4 respectively. With the necessary changes and with due alteration of details it is similarly possible to implement angular subsampling by any factor and with any number of elementary pixels per hogel.

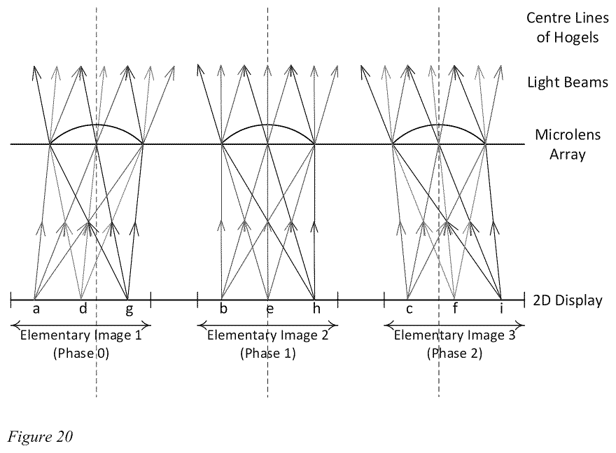

The implementation of angular subsampling by modulating the position of the elementary images, may be based on known microlens light field displays. The advantage of using microlenses is, as before, that the resulting display is much brighter than a pinhole display. FIG. 20, illustrates modulating the position of the elementary images in a microlens array light field display. It is analogous to FIG. 15 in the same way that FIG. 17 is analogous to FIG. 9. In this implementation the relationship between the positions of the centers of the microlenses and the elementary images is precisely the same as in FIG. 15. Consequently, each hogel produces the same angular distribution of rays as the corresponding hogel does in FIG. 15. A disadvantage of this implementation compared to FIG. 15, is that it requires that a small gap be left between adjacent hogels to accommodate modulating the position of the elementary images. With the necessary changes and with due alteration of details it is similarly possible to implement angular subsampling by any factor and with any number of elementary pixels per hogel.

An alternative to modulating the physical position of the elementary pixels, is to modulate the position of the elementary image, displayed thereon, by changing the intensities of the elementary pixels. The offset required for any specific elementary image is less than one pixel width. Hence, shifting the image, rather than the physical pixels, requires sub-pixels shifts. The signal processing required for sub-pixel shifts has been well known for many decades and may be implemented in a plethora of ways.

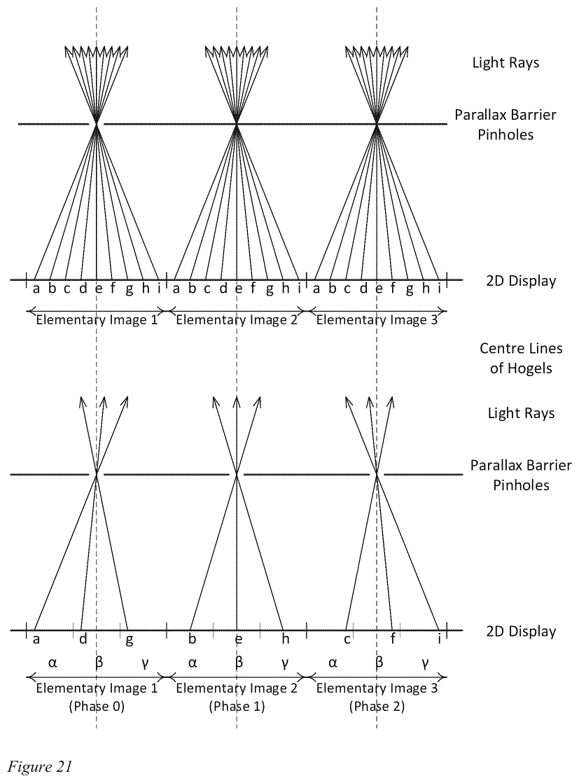

FIG. 21 illustrates the principal of this implementation. For clarity it is shown for a lightfield display using pinholes, not microlenses. Microlenses may equally well be used instead of pinholes (cf. FIGS. 9b and or 17b and 20). The origin of the rays in FIG. 21b (bottom) are shown in relation to the rays in corresponding hogel in FIG. 21a (top). In FIG. 21b, however, the rays (corresponding to Phase 0 and Phase 2 in this example) no longer emanate from the center of the three elementary pixels. For example, considering the left hand hogel in FIG. 21b (Phase 0), rays “a”, “d”, and “g”, emanate from towards the left-hand side of their respective elementary pixels. To achieve this, new intensities must be generated for the elementary pixels in FIG. 21b. These new intensities are labelled as “α”, “β”, and “γ”, and are shown at the center point of their elementary pixel.

An example is useful to clarify calculating the new elementary pixel intensities. For this example, it is useful to consider the original elementary ray intensities, “a” to “i” shown in FIG. 21a. These rays represent a limited range of angles that determine the viewing angle of the display. A display with a wider viewing angle would have more rays with their associated intensities that are not shown in FIG. 21a. It is useful to consider these additional ray intensities when calculating the new elementary pixel intensities, “α”, “β”, and “γ”. Consider such an augmented set of 15 ray intensities, rather than the original 9, denoted “x”, “y”, “z”, “a”, “b”, . . . “h”, “i”, “j”, “k”, and “I”, where “x”, “y”, “z” are supplementary intensities to the left of “a” and “j”, “k”, and “I” are supplementary intensities to the right of “i”. Now consider the augmented set of intensities for the left most hogel in FIG. 21b. These are a 3:1 subsampled set of the 15 ray intensities. They would be “x”, “a”, “d”, “g”, and “j”, which includes a supplementary intensity on both the left and the right. In the left most hogel (phase 0) of FIG. 17b, or 21, the physical pixels that make up the elementary image are shifted ⅓ of an elementary pixel width to the left. Similarly, the physical pixels for the right most hogel (phase 2) were shifted ⅓ of an elementary pixel width to the right. We need to shift the elementary image, in phase 0 hogel of FIG. 21b, ⅓ of an elementary pixel width to the left, by interpolating new intensities, “α”, “β”, and “γ” corresponding to the 3, unmoved, elementary pixels. This can be done by linear interpolation as follows:

$$\begin{matrix}α = \frac{1}{3} x + \frac{2}{3} a \\ β = \frac{1}{3} a + \frac{2}{3} d \\ γ = \frac{1}{3} d + \frac{2}{3} g\end{matrix}$$

It is important to note that only the 3:1 subsampled subset of pixels corresponding to phase 0 (i.e. “x”, “a”, “d”, “g”, and “j”) are used in this interpolation.

The new interpolated intensities of the elementary pixels for the right most hogel in FIG. 21b may be calculated similarly. These intensities are calculated from the 3:1 subsampled subset of pixels corresponding to phase 2, that is from “z”, “c”, “f”, “i”, and “I” only. We need to shift the elementary image, in phase 2 hogel of 21b, ⅓ of an elementary pixel width to the right, by interpolating new intensities, “α”, β″, and “γ” for the 3, unmoved, elementary pixels. The linear interpolation of these new intensities is:

$$\begin{matrix}α = \frac{2}{3} c + \frac{1}{3} f \\ β = \frac{2}{3} f + \frac{1}{3} i \\ γ = \frac{2}{3} i + \frac{1}{3} l\end{matrix}$$

The augmentation of the set of ray intensities, to facilitate interpolation, is of minor significance in practice. It is an example of the well-known need for “edge extension” in image signal processing. It assumes a disproportionate importance in the above examples simply because there are only three elementary pixels in each hogel in FIG. 21b. In practice there would be many elementary pixels and edge extension would only affect the interpolated values for a few elementary pixels at the edge of the elementary image. The supplementary intensities may be obtained in several ways. For example, they would be calculated by rendering the 3D scene model in the same way it is rendered to produce the intensity of any other elementary pixel. If that is not practical, then the supplementary pixels might be set to the nearest edge pixel. In the above example this would mean that “x”, “y”, and “z” would all be set to the value of “a”, and “j”, “k”, and “I” would be set to the value of “I”. Even simpler, the supplementary intensities could arbitrarily be set to a constant value, typically zero.

In a practical display interpolating elementary pixel intensities, to displace, or modulate, the position of the elementary image, would be performed in both of the two, horizontal and vertical, dimensions. This may be achieved, for example, by extending the linear interpolation above to the well-known bilinear interpolation.

Linear interpolation is a relatively inaccurate way to interpolate an image and is discussed here only as a simple exemplar. There are many well known techniques that are better, such as cubic interpolation (or bi-cubic in two dimensions). More typically the interpolation would be performed by a linear convolutional filter such as the well-know Lanczos family of interpolators. More generally, image interpolation may be performed as a function of neighboring, or “local”, samples, where the function may be non-linear.

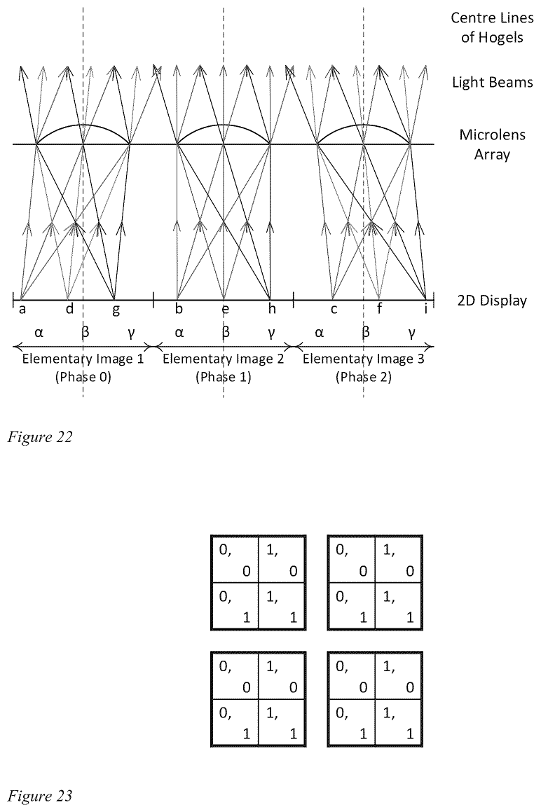

By modulating the position of the elementary image via interpolation, a gap between adjacent hogels is no longer required. This results in the implementation shown in FIG. 22. The physical structure of the light field display is that of the known light field display, illustrated in FIG. 7. The distinction is that intensities of the elementary pixels are different, derived by subsampling the intensities that would be used in a known display, and interpolating those subsampled intensities.

The implementation of FIG. 22 has several significant advantages. The physical implementation of the display is relatively simple and does not require additional, or modified, optical components beyond those in a known light field display (FIG. 7). Only the intensities generated by the elementary pixels, and the associated signal processing to derive them, is different. Hence it may be possible to retrofit the technique of angular subsampling to existing display hardware. The position of every elementary image may be changed in each “frame” that is displayed. Hence implementation of FIG. 22 facilitates combination of the techniques of spatial and temporal angular subsampling; indeed, there is little distinction between them. Since no moving parts, nor even time changing optical components, are required, high frame rates are easier to achieve when applying temporal or combined temporal and spatial angular subsampling. Furthermore, it is simple to configure the light field display to present a 2D image coincident with the display, i.e. configure it as a conventional 2D display, by setting all the elementary pixel intensities in a hogel to the value of the corresponding 2D pixel.

### Example of Spatial Angular Subsampling

This subsection provides a simple, illustrative, example of spatial angular subsampling. The example considers an extremely simple lightfield display consisting of a 2×2 array of hogels, each with a 2×2 array of elementary pixels. It describes implementing 2:1 subsampling both horizontally and vertically. The example is far too limited to be of practical utility. It is presented here only to illustrate the principle. A more realistic example is presented below.

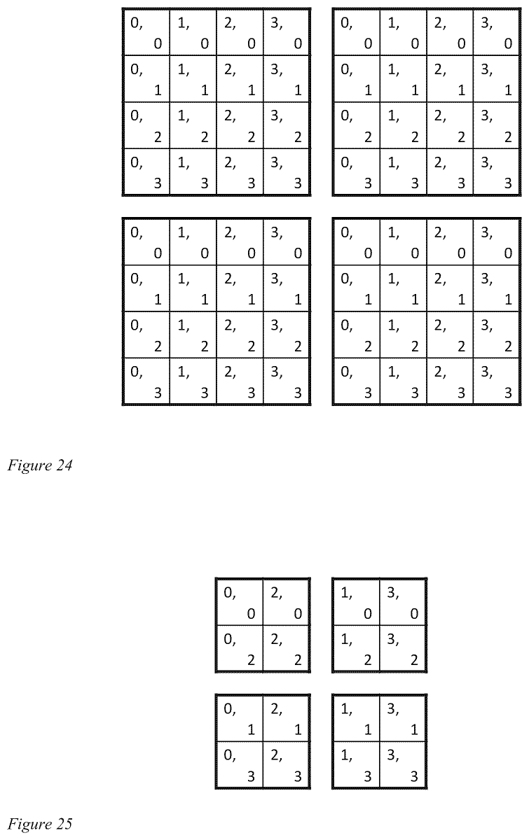

FIG. 23 enumerates the spatial coordinates of the elementary pixels in each physical hogel. Implementing 2:1 angular subsampling allows this physical lightfield display to emulate a notional display with twice as many elementary pixels in each direction, i.e. with an 4×4 array of elementary pixels per hogel. The elementary pixels' coordinates for this notional display are shown in FIG. 24. To implement spatial angular subsampling some of the pixel coordinates from the notional display are mapped to the physical display. Only one quarter of the notional pixel coordinates are mapped, thus implementing subsampling. The pixel coordinates mapped to the physical elementary pixel always come from the corresponding hogel in the notional display. That is, pixel coordinates from the top left notional hogel are mapped to the top left physical hogel, and so on. FIG. 25 enumerates how pixels are mapped from the notional to the physical display.

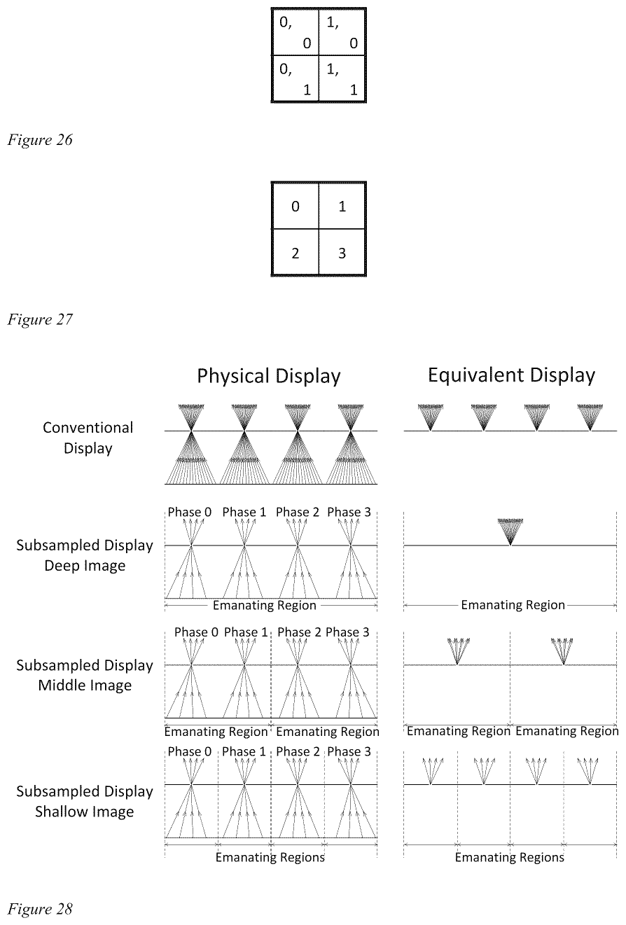

The top left coordinate is different in each hogel in FIG. 25. That is, each hogel in the notional display (FIG. 24) is subsampled in a different phase. The subsampling phase is defined by the top left coordinate in FIG. 25. Hence, we have the 2×2 array of subsampling phases, with one entry for each physical hogel, defined in FIG. 26.

The subsampling phases, defined in FIG. 26, may be labelled as enumerated in FIG. 27.

Since there are 4 possible phases, each used once, in any of 4 possible positions, there are a total of 4 factorial (24) possible permutations of these phases. Any one of these permutations may be used to implement spatial subsampling in this example; it makes little difference which permutation is used. But in a more realistic example, with a larger subsampling ratio, it is important to choose a good permutation of subsampling phases.

### Phase Permutation— Displaying Images at Multiple Depths Simultaneously

Hitherto this description has mainly considered single point objects, but real scenes comprise many points at different depths. For a single point object, a subsampling ratio appropriate for rendering that point can be calculated. Yet, for a practical display, we must be able to render image points in the scene over a range of depths. This section considers how a display implementing angular subsampling with a single subsampling ratio may, nevertheless, properly render multiple parts of an image at different depths. The technique described may be called “phase permutation”. It is described in one dimension but is easily extrapolated to the two dimensions required in practice. This section only considers the case where a display is rendering virtual images on or behind the display surfaces. That is, in which all the image points are at depth d≥0. The case of also displaying real images in front of the display (d<0) is considered in the later section “Oversampling lightfield displays”.

It is important to bear in mind how the separation of hogels, and the number of elementary pixels needed to properly render an image in a known lightfield display, vary with the depth of that image. A display has a certain number of hogels with a separation x0 between them. This number of hogels is only needed for images at the display surface. For virtual images behind the display fewer hogels are needed (i.e. the hogels may be further apart). Conversely the full number of elementary pixels, N_{∞}, are only needed for images at infinity. To present images nearer to the display fewer elementary pixels are needed. That is, when focusing at a shallow depth, a viewer does not need to see the full set of angular beams that would be required to focus a deeper image.

The minimum separation of hogels, xₛ, and the number of elementary pixels, Nₑ, needed to present an image at depth d, are given in equations 1 and 2, reprised here for convenience (where v is the viewing distance):

$${x}_{s} = {x}_{0} \cdot ( 1 + \frac{d}{v} ) \qquad Equation 1 ( a )$$

$${u}_{s} = {u}_{∞} \cdot ( 1 + \frac{v}{d} ) \qquad Equation 1 ( b )$$

$${N}_{e} = \frac{{N}_{∞}}{( 1 + \frac{v}{d} )} \qquad Equation 2$$

Clearly the separation of hogels in a physical display (x₀) is fixed. But equation 1(a) shows that not all the hogels are required to render an object behind the display. So, in a sense, there are “excess” hogels when rendering an object behind the display. Similarly, whilst the number of physical elementary pixels in a display is fixed, more are needed for rendering a deeper object than a shallow object. In this sense there is an “excess” of elementary pixels when rendering shallow objects.

Were it possible, a display might choose to vary the hogel spacing and the number of elementary pixels per hogel when displaying objects at different depths. This would allow a fixed total number of elementary pixels to be deployed in the most effective way and would avoid the consequence of excess hogels or excess elementary pixels described above. For example, when displaying objects close to, or in front of, a display it would use many, closely spaced hogels, each with few elementary pixels per hogel. On the other hand, when displaying an object at a large depth behind the display, it would use few sparely spaced hogels each with many elementary pixels. However, varying the hogel spacing is not possible, both because it is fixed by the construction of the display and because the display must simultaneously be able to display objects both near to, and far away from, the display.

This disclosure recognizes that, whilst physically changing the spacing of hogels is not possible, it is possible to emulate such variability by taking advantage of the optics of the eye, or camera, viewing the display. Furthermore, it is possible to, simultaneously, emulate a small hogel spacing for objects near to the display, a large hogel spacing for objects at a large depth behind the display, and intermediate hogel spacing for objects at intermediate depths. The eye (or camera) combines rays from multiple physical hogels within the emanating region; using angular subsampling allows a display to emulate larger hogels (bigger x0) with more elementary pixels. Emulating larger hogels allows the display to render image points properly at greater depths. Such an emulation can also enable a display to, simultaneously, render image points at multiple depths using a single subsampling ratio.

Equation 5, reprised below, shows that the size of the emanating region increases in a very similar way (identical except for the psf) to the increase in the minimum number of elementary pixels with depth, described in equation 2.

$$s = p \cdot \vert \frac{1}{1 + ( v / d )} \vert + psf \qquad Equation 5$$

This disclosure recognizes that, if the subsampling ratio is calculated using a slightly smaller emanating region (excluding the psf), then a lightfield display using angular subsampling intrinsically emulates a hogel spacing that varies with the depth of the object being displayed according to equation 2. That is, the subsampling ratio may be calculated using:

$$s = p \cdot \vert \frac{1}{1 + ( v / d )} \vert \qquad Equation 6$$

The effective hogel size is the size of the emanating region (according to Equation 6), and the effective number of elementary pixels is the combined number of elementary pixels of the physical hogels within the emanating region. Note well that the effective hogel size, and effective number of elementary pixels, depends on the depth of the object being displayed. Consequently, since a (physical) hogel may simultaneously emit light corresponding to more than one object, the hogel size is simultaneously optimized for objects displayed at multiple depths.

When applying angular subsampling it would be natural to use a linear ordering of subsampling phases. Consider a lightfield display applying 4:1 angular subsampling, which might emulate a notional known lightfield display with 16 elementary pixels per hogel (in each dimension), as illustrated (in one dimension) in the top row of FIG. 28. The 16 elementary pixels in each hogel, or equivalently the light rays that they emit, may be labelled from zero to 15, i.e. [0, 1, 2, 3, 4, 5, 6, 7, 8, 9, 10, 11, 12, 13, 14, 15]. Angular subsampling by 4:1 would take equally spaced subsets, of four ray directions, in adjacent hogels, as illustrated in the second row of FIG. 28. A natural way to choose these subsets would be as [0, 4, 8, 12], [1, 5, 9, 13], [2, 6, 10, 14], and [3, 7, 11, 15]. These subsets are distinguished by their subsampling phase, which may conveniently be labelled as the direction of the first ray in each subset, i.e. as subsets 0, 1, 2, and 3 respectively. If these subsets of rays are allocated to adjacent hogels in this order, as illustrated in the second row of FIG. 28, it may be described as a linear ordering of subsampling phases. Whilst a linear ordering of subsampling phases works well to display both shallow and deep objects it is less well suited for the display of objects at intermediate depths, as explained below.

To mitigate the effects of a linear ordering of subsampling phases, when displaying objects at intermediate depths, a preferred order for the subsampling phases may be selected. FIG. 28 illustrates emulating larger hogels with more ray directions (effectively more elementary pixels). It also illustrates why selecting a preferred order of the subsampling phases may be beneficial.

The top row of FIG. 28 shows a known lightfield display with 16 elementary pixels per hogel (i.e. 16 uniformly spaced ray directions). This is similar to FIG. 11a, but with more elementary pixels. The left of that row shows the generation of rays by four adjacent hogels. The right-hand side shows the spatial and angular sampling of the rays as seen by the eye. The second row shows a lightfield display using 4:1 angular subsampling, with the subsampling phases arranged in a linear progression (left to right from phase 0 to phase 3). It is assumed that, with 4:1 subsampling, the emanating region spans four physical hogels when rendering at the maximum depth of field. This is equivalent, for images rendered at this depth, to having 4 times the hogel separation, but the full 16 ray directions. This is illustrated on the right-hand side. In a sense this is equivalent to having hogels with four times their physical separation but with four times as many elementary pixels (larger hogels with more elementary pixels). Skipping to the last row of the Fig., image points at shallow depths may have an emanating region which is only a single physical hogel wide. Such image points have the minimum separation between hogels, but only four ray angles. However, the image point will still be properly rendered because shallow image points require fewer ray angles (equations 1 & 2).

Unfortunately, in FIG. 28, image points at intermediate depths (3rd row, “middle image”) would not be rendered without distortion. Image points at such depths might have an emanating region that is two hogels wide. They would require an equivalent display with twice the physical hogel separation and with each hogel producing half the number, i.e. 8, rays. Whilst the right hand of the FIG. illustrates equivalent hogels with twice the physical separation, the hogels do not generate the 8, uniformly spaced, rays that are required. The problem is that the rays are not equally spaced. Since the phases are in linear order (i.e. 0, 1, 2, 3), there are two closely spaced rays, followed by a larger gap, then two more closely spaced rays, and so on.

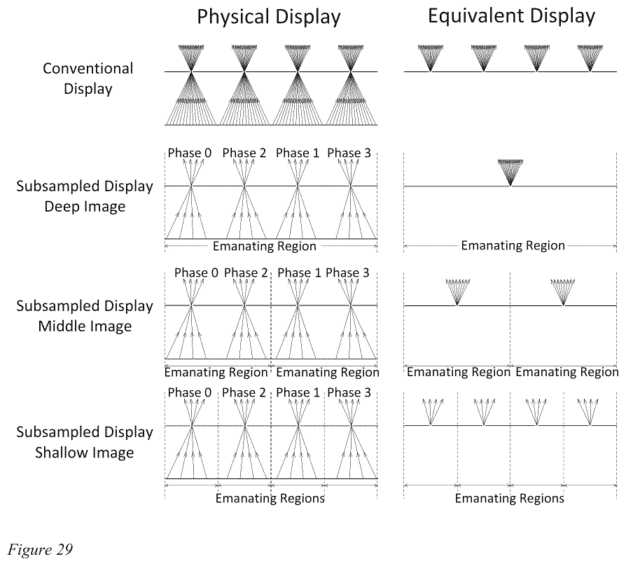

The problem of unequally spaced rays, when rendering image points at an intermediate depth, may be addressed by changing the order of the subsampling phases, or “phase permutation”. FIG. 29 is only subtly different from FIG. 28 but, by using a different permutation of subsampling phases, (0, 2, 1, 3) instead of the linear ordering (0, 1, 2, 3), it allows image points at intermediate depths to be rendered without distortion. With this change, the hogels on the equivalent display (third row on the right-hand side) produce equally spaced rays for image points at intermediate depths, and so can render such points without distortion.

A lightfield display using angular subsampling, implemented with fixed subsampling factors can also present images correctly over the full range of depth, provided the subsampling phases are chosen with care. The order of the phases may be such that the magnitudes of adjacent phases differ as much as possible.

Subsampling phases may be considered as equally spaced in a circle, i.e. as modulo numbers. This is analogous to the numbers on a clock face, which are modulo 12. The two hands on a clock face cannot get further than 6 numbers apart; after that they get closer together again. Analogously, with 4:1 subsampling there are four phases which cannot be separated by more than “2”. Consequently, the maximum magnitude difference between any pair of phases in a set of 4 phases is 2. More generally, for a set of n phases, the maximum phase difference between any pair is n/2.

It is not, generally, possible for all the magnitude phase differences within a phase permutation to attain the maximum possible difference. Therefore, in choosing a good phase permutation, a permutation with a high “average” difference should be selected. The average may, for example, be the arithmetic mean, but a different metric for combining magnitude differences may alternatively be used.

The phase order used in FIG. 29 was generated by bit reversing the linear phase order, which ensures a good phase order. To bit reverse the phase order the linear order (0, 1, 2, 3) is represented in binary notation (i.e. 00, 01, 10, 11), the order of the bits is reversed (yielding 00, 10, 01, 11), and then converted back to the decimal representation (to give 0, 2, 1, 3). There is not a unique “best” phase order, but bit reversing linear ordering yields one good phase order.

A practical display would be two-dimensional. In two dimensions there are more phases, and hence more phase orders, or permutations, are possible. In a good 2D phase permutation adjacent phases would differ as much as possible. For example, with 4:1 angular subsampling applied both horizontally and vertically, there are 16 different (2 dimensional) phases. With 16 phases there are 16 factorial (20,922,789,888,000) possible permutations. Many of these permutations might provide good image rendering over a range of depth. Two practical examples of phase permutations are given in the design example below.

### Example Design of a Lightfield Display Using Angular Subsampling and Phase Permutation

To support the foregoing explanation, this description now provides an example of a design for a lightfield display. This example is based on the (two dimensional) display used in the “Sony Xperia XZ Premium” mobile phone, which was first released on the 30 Jul. 2018. The display on this phone is 5.5″ diagonal, with a UHD resolution, i.e. 3840×2160 pixels, and an aspect ratio of 16 by 9 (i.e., like most modern displays, it has “square” pixels). Firstly, the provision of lightfield display according to existing approaches, using these phone display parameters, is considered. This is then enhanced, using spatial subsampling with phase permutation, to provide a greater depth of field.

The width of the Xperia display is about 12.18 cm, corresponding to its diagonal dimension of 5.5″. The design assumes a viewing distance of twice the width of the display, that is, 24.36 cm.

In this example the lightfield display is implemented using an array of microlens, as illustrated in FIG. 7. The design requires that the focal length of the lenses, or equivalently their “f number” (denoted f #, and defined as focal length divided by their aperture), be chosen. The f #number depends on the viewing distance and the range of viewing positions as described below. This example design uses an f #of 2, which is typical for lightfield displays.

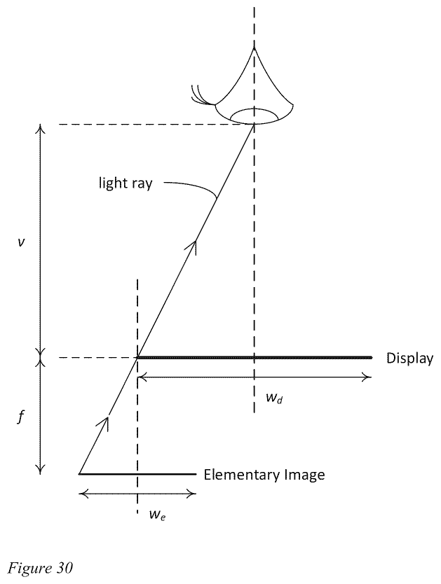

An f #number of 2 only provides the full 3D image from a single viewing position at the center of the display. A less restricted viewing position can be achieved using a lens with a lower f #, but at the expense of a reduced depth of field. FIG. 30 illustrates why an f # of about 2 is typically required. It shows the angle of a light ray, from the edge of the display to a central viewer, relative to the display normal. Unless the display can generate rays at this angle then a central viewer cannot see a hogel at the edge of the display. Beneath the surface of the lightfield display (i.e. the surface of the microlens array) FIG. 30 illustrates (at an exaggerated scale) the maximum ray angle that can be generated by the edge most elementary pixel in each hogel. Clearly the triangle with apexes at the edge of the display, at the center of the display and at the viewing position (i.e. the triangle above the display) is similar to the triangle with apexes at the edge of the elementary image, the center of the elementary image and the center of the hogel microlens (i.e. the triangle below the display). If the distance of the viewer from the display, v, is twice the width of the display wd, then the distance of the lens from the elementary pixels, f, must be twice the width of the elementary image. Assuming the microlens covers the full width of a hogel, i.e. equals we, then the lens must have an f # of 2.

To complete the design of the known lightfield display this example chooses to have a 16 by 16 array of elementary pixels behind each hogel. This means that the hogel resolution is 240 by 135 (i.e. the display resolution divided by 16 in each dimension).

### Summary of Design Parameters:

Screen size: 12.18×6.85 cm
Display resolution: 3840×1920
Assumed viewing distance: 24.36 cm
Microlens f #: 2.0
Hogel resolution: 240×135
Elementary pixels per hogel: 16×16
Hogel Size: 0.507×0.507 mm
Distance of microlens array from display (f #×hogel size): 1.014 mm

Given these design parameters the depth of field for this known design may be calculated using the formulae provided by equations 1a and 1b. The depth of field, such that the spatial resolution of the image, in mm, is the same as at the display surface, may be calculated using equation 7 from the Borer article. For the purposes of this description that equation is best reformulated in terms of the design parameters. Equation 7 from the Borer article is equivalent to:

D_{absolute}=g·Nₑ Equation 7

Where D_{absolute} is the depth of field, Ne is the number of elementary pixels (16 in this example), and g is the gap between elemental pixels and the lenslet array. Substituting for g gives:

D_{absolute}=x₀·f#·Nₑ Equation 8
where x₀ is the size of the hogel. Substituting x₀=0.507, f #=2, and Nₑ=16 gives a depth of field for this design of 16.22 mm.

The Borer article also provides a second formula, its equation 16, for the depth of field such that the angular resolution of the 3D image (i.e. the angle of the smallest image detail subtended at the eye) is equal to (or greater than) the angular resolution of the 3D image at the display surface. This second formula corresponds more closely to how images are perceived by the human visual system and so is a preferred metric for the depth of field. Again, it is better to reformulate equation 16 (from the Borer article) in terms of the physical design parameters. Making this reformulation gives (for virtual images behind the display):

$${D}_{a n g u l a r} = \frac{v}{( \frac{v}{{D}_{absolute}} - 1 )} \qquad Equation 9$$

where D_{angular} is the depth of field in terms of angular resolution, and v is the viewing distance (24.36 cm in this example). Substituting for v and D_{absolute}, as calculated above, (and using the same units for both!) gives a depth of field by this metric of 17.38 mm.

The absolute and angular metrics for depth of field are very similar in this example because the depth of field is small. However, for greater depths of field the angular metric may be considerably bigger and is more accurate perceptually.

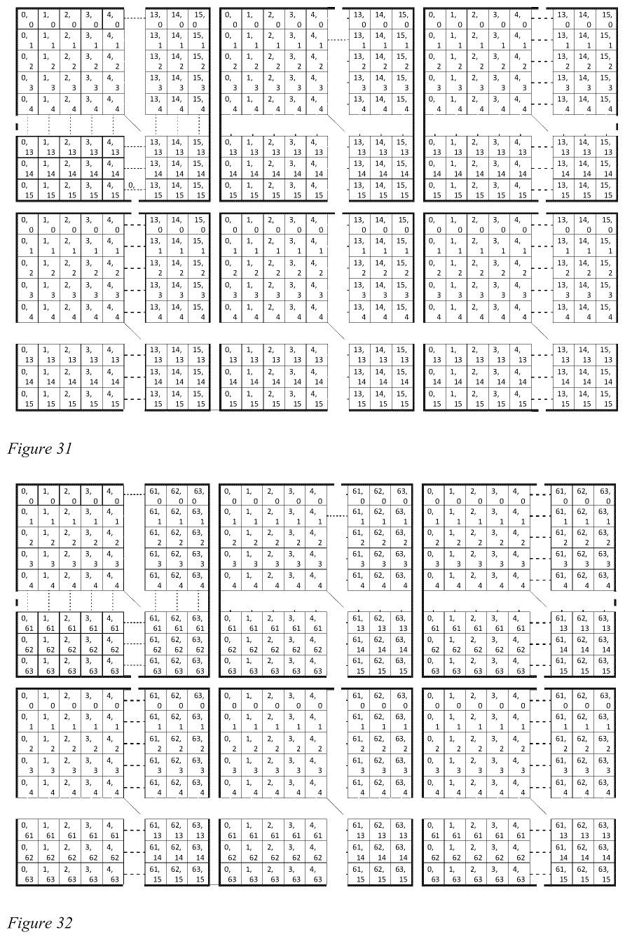

FIG. 31 enumerates the elementary pixel coordinates for the top left 6 hogels (i.e. the left 3 hogels from the top 2 rows) in this design. The other hogels may be extrapolated from those shown. It is essentially a map of the coordinates within each elementary image. Ideally it would include the coordinates for all hogels and all elementary pixels, but space precludes it. Only the starting and ending coordinates of the elementary pixels are shown due to limitations of space. However, the missing detail is easily extrapolated from what is shown. The coordinates of the elementary pixels are given in the form (horizontal position, vertical position).

Having chosen design parameters for a known lightfield display configuration based on the Xperia phone display, the design may be enhanced, in terms of depth of field, using spatial angular subsampling. In this example 4:1 angular subsampling is chosen (both horizontally and vertically). Angular subsampling emulates a notional lightfield display with more elementary pixels than there are in the physical display. By so doing it achieves a greater depth of field. In this example, with 4:1 subsampling, a notional known display with 4 times more elementary pixels per hogel (in each dimension) is emulated, whilst the other design parameters remain the same. This notional physical display would be the same size as the Xperia display, but with 4 times the resolution (in each dimension). That is, it corresponds to a 12.18×6.85 cm display with resolution 15,360×8,640. The angular subsampled design corresponds to the notional display with elementary pixel coordinates shown in FIG. 32.

The depth of field for the known lightfield display that we are emulating may be calculated using equation 9. Calculating first D_{absolute}, substituting x₀=0.507, f #=2, and Ne=64, gives an (absolute) depth of field for this design of 64.90 mm. Then substituting this value into equation 9, with viewing distance v=24.36 cm, gives depth of field in terms of angular resolution of 8.85 cm. This is an improvement, compared to the known implementation with angular depth of field 1.738 cm, by a factor of 5.09.

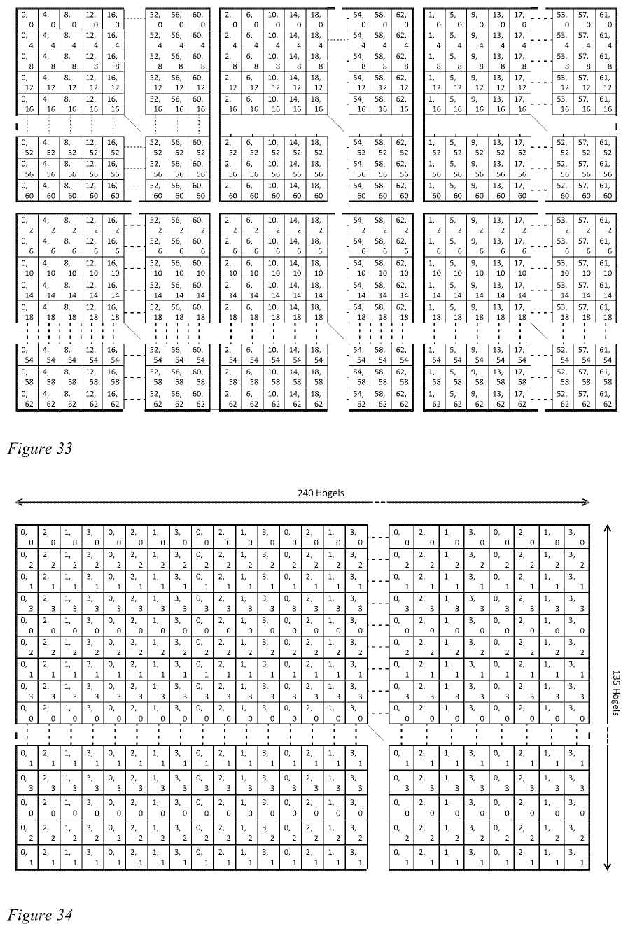

To enumerate further, this example design uses a permutation of phases of 0, 2, 1, 3 (rather than a linear progression of phases 0, 1, 2, 3). In each elementary image the notional elementary pixel coordinates, shown in FIG. 32, are subsampled to yield a subset of elementary pixels, which are mapped to the physical elementary pixels that are available, as shown in FIG. 33.

In the top left elementary image, illustrated in FIG. 33, the top left elementary pixel is mapped from the, notional, top left elementary pixel in FIG. 32. This corresponds to phase (0, 0) (where the two coordinates are the horizontal phase followed by the vertical phase). Subsequent elementary pixel coordinates (both horizontal and vertical) increment by 4 so that the mapped pixels fit into the physical pixels available on the display. In the second elementary image (middle of the top row in FIG. 33) the top left elementary pixel is mapped from the third left notional elementary pixel (with coordinate (2, 0)) in FIG. 32. That is, the second elementary image corresponds to phase (2, 0). Again, the mapped pixels have coordinates that increment by 4 from the corresponding notional elementary image (in FIG. 32). Looking at the second row of elementary pixels in FIG. 33, note that the vertical phase is 2. Hence the left elementary image in row two maps its first (i.e. top left) pixel from pixel (0, 2) of the corresponding elementary image in FIG. 32. That is the left most elementary image in the second row of FIG. 33 has a subsampling phase of (0,2). In each of the elementary images in FIG. 33, the coordinates of the elementary pixels mapped from FIG. 32 increment by 4 (horizontally and vertically) in consecutive pixels. Note that pixels mapped into elementary images in FIG. 33 always come from the corresponding elementary image in FIG. 32. Although there is limited space to enumerate all the pixel coordinates in FIG. 33 (there are 3840×2160=8,294,400 pixels in total!), the reader may extrapolate the elided pixels coordinates from those shown.

It may help to understand the pixel enumeration in FIG. 33 by considering FIG. 34. FIG. 34 shows only the coordinate, mapped from FIG. 32, for the top left elementary pixel of each elementary image. That is, FIG. 34 is a map of the subsampling phases for the elementary images in this example design. It shows the subsampling phases for the array of 240×135 hogels. Some of the phases are elided due to constraints on space, but the elided values may be easily interpolated from those shown. The top left value for each hogel is the horizontal phase and the bottom right value is the vertical phase. That is the phase coordinates are (top left, bottom right).

Whilst the example of FIG. 34 shows the pattern of phases in a 4×4 array of hogels repeated over the display, in other examples according to the present disclosure, different patterns of the phases may be used in different hogels. For example, a pattern used in one array of hogels could be rotated, reflected and/or inverted in another array of hogels in the display. Furthermore, different patterns could be arranged in sequence, or randomly, over the display.

### Alternative Subsampling Phases for a Design Example

This section presents an alternative permutation of subsampling phases with superior properties for viewing images at multiple depths.

Previously it has been noted that a lightfield display using angular subsampling, designed with specific subsampling factors horizontally and vertically, can also present images correctly over its full range of depth. In order to do this a suitable, 2-dimensional, permutation of subsampling phases should be chosen to optimize the reproduction of images over the desired depth range. A good permutation would have, inter alia, adjacent phases that differ as much as possible. The example just given provides one such possible permutation. A permutation of the four subsampling phases, was chosen, 0, 3, 1, 2, and applied separately horizontally and vertically to create a 4×4 pattern of subsampling phases. This 4×4 pattern was then repeated horizontally and vertically to cover the all hogels.

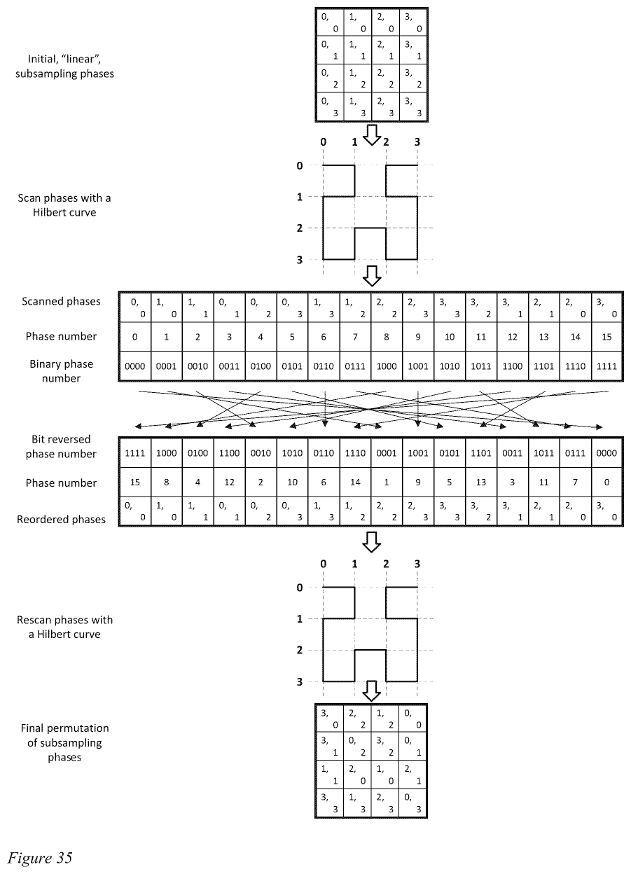

Adjacent phases can be made to differ as much as possible by taking account of both horizonal and vertical phases together, rather than treating then independently. In two dimensions, with 4:1 subsampling, there are 16 possible 2-dimensional phases. These can be scanned using a Hilbert curve (or similar, en.wikipedia.org/wiki/Hilbert_curve), which yields a list of 2D phases that are close together. Applying the same procedure as above, i.e. bit reversing their order, produces a list of 2D phases that are far apart. Then rescanning this bit reversed list using a Hilbert curve we end up with 2D phases, originally far apart, clustered together. This ensures adjacent phases differ significantly, as is required to present images at a range of depths. The process of calculating this improved permutation of phases is illustrated in FIG. 35. Note that the bit reversed phase numbers are placed in linear order, resulting in a phase order of ((3,0), (2,2), (0,2), . . . , (0,0)), before they are rescanned using the second Hilbert curve.

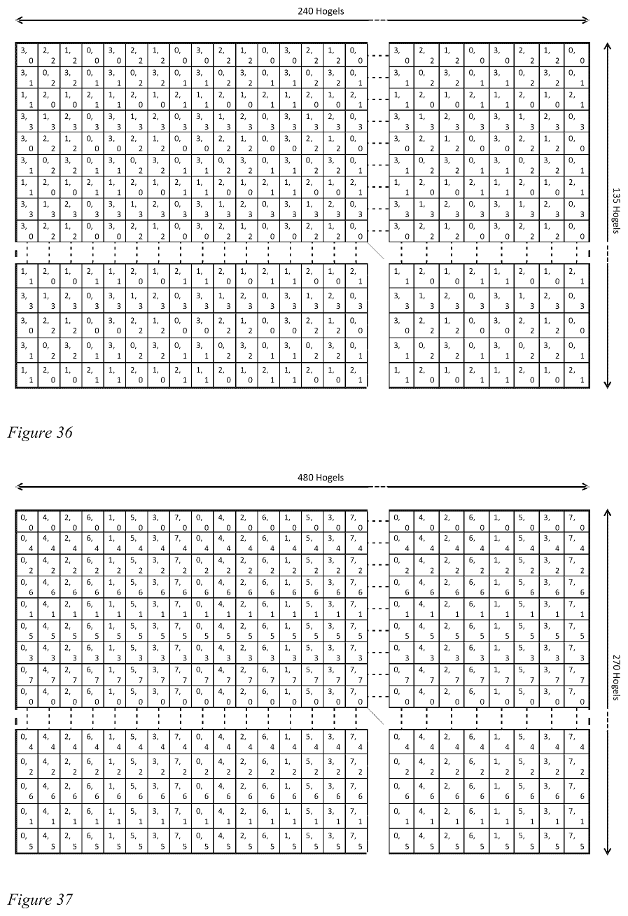

This 2-dimensional permutation, of the 4×4, array of subsampling phases, may then be repeated and tessellated to cover all the hogels in the example design. Doing so yields the mapping of subsample phases shown in FIG. 36.

### Oversampled Lightfield Displays

Sometimes it may be useful to have more hogels, each with fewer elementary pixels. One case would be to generate real images in front of the display. A second case would be to allow a lightfield display to emulate a known 2D display at a higher resolution. This section addresses both cases using the same technique of spatial oversampling. It produces a spatially oversampled, angularly subsampled, lightfield display, herein simply referred to as an “oversampled” display. This section describes how the example design may be modified to achieve this.

### Presenting Real 3D Images

If a lightfield display is required to display real images in front of the display it needs more hogels (i.e. a smaller hogel separation) than to display virtual images behind the display. This follows from equation 1, reprised again below:

$${x}_{s} = {x}_{0} \cdot ( 1 + \frac{d}{v} ) \qquad Equation 1 ( a )$$

$${u}_{s} = {u}_{∞} \cdot ( 1 + \frac{v}{d} ) \qquad Equation 1 ( b )$$

For example, suppose the display were required to generate an image halfway between the viewer and the display, that is, at a depth d=−v/2 (negative depth because it is a real image in front of the display). Equation 1a shows that xₛ=x₀/2, i.e. the pixel separation is half that needed to display an image at the display surface with the same angular resolution. In other words, we need twice as many hogels.

$${N}_{e} = \frac{{N}_{∞}}{( 1 + \frac{v}{d} )} \qquad Equation 2$$

Equation 2, reprised again above, shows that few elementary pixels are required to render images at shallow depths near the display surface. Hence, the number of hogels can be increased, with a corresponding reduction in the number of elementary pixels, without degrading the ability to display shallow images. Equation 2 also shows that the number of elementary pixels, Ne, needed increases with the depth of a virtual image, reaching a maximum of N_{∞} at infinite depth. With a known lightfield display, as the number of hogels is increased, the number of elementary pixels decreases, thereby reducing the depth of field. Consequently, there is a trade-off between the resolution of an image coincident with or in front of the display, and the depth of field behind the display. This trade-off does not apply to oversampled lightfield displays, as explained below.

An oversampled 3D display is one in which there are more hogels than are required to render the chosen resolution of an image coincident with the surface of the display. If the design were intended to support a resolution of, say h by v pixels, for a 2D image at the display (i.e. when displaying a known 2D image), then an oversampled display would have more than h by v hogels. For example, considering the design above, an oversampled display might instead have 480 by 270 hogels rather than 240 by 136 hogels.

With oversampled lightfield displays there can be more hogels, and correspondingly fewer elementary pixels, without degrading the depth of field for virtual images. For example, the number of hogels may be doubled, and the number of elementary pixels halved, whilst maintaining the same depth of field. The size of the emanating region is determined by the size of the eye's pupil (assumed to be 4 mm, above), so as the hogels get smaller more of them fall within the emanating region. The increase in the number of hogels in the emanating region compensates the reduction in the number of elementary pixels (see equation 6 above).

### Emulating Higher Resolution 2D Displays

Angular subsampling facilitates making lightfield displays which can also function as known 2D displays. This is important because displays will have to present both 2D and 3D images. For the entertainment industry, for example, there is a large and growing catalogue of 2D films and TV programs, which will need to be displayed on the same screen as new “holographic” 3D lightfield content.

A lightfield display can easily emulate a known 2D display, where each hogel corresponds to a pixel on the known display. To achieve this, the luminous intensity from the hogel should be proportional to the cosine of the angle to the normal at which it is emitted. This makes the hogel a Lambertian emitter, corresponding to an ideal pixel on a 2D display. All that is required is to make the elementary image display an appropriate pattern, with luminous intensity proportional to the desired pixel luminance.

Oversampling can also enable lightfield displays to present 2D images at higher resolution than would otherwise be possible. All lightfield displays have a fixed number of hogels (i.e. their hogel resolution). The number of hogels determines the maximum spatial resolution of a 2D image coincident with the display. That is, the hogel resolution defines the resolution when emulating a 2D display. The resolution of a lightfield display is constrained by the total number of pixels available in the underlying 2D display. Since a lightfield display requires multiple elementary pixels per hogel it is inevitable that it will have a lower resolution than a 2D display.

The design example above, without oversampling, uses a 2D display with horizontal resolution of 3840 pixels as the basis of a lightfield display with 240 pixel hogel resolution. That design, angular subsampling notwithstanding, can only present 2D images with 16 times less resolution than the underlying display. The display design is obliged to trade off depth of field for 3D images against the resolution of 2D images; fewer elementary pixels per hogel means more 2D resolution but reduced depth of field. A designer might feel that a 4 k UHD resolution 2D image has better subjective quality than a 240 hogel resolution 3D lightfield image. Oversampling allows the designer to mitigate this trade-off.

### Design Example Using Oversampling

To clarify this explanation the design example above may be modified to implement oversampling.

### Modified Design Parameters:

Screen size: 12.18×6.85 cm
Display resolution: 3840×1920
Assumed viewing distance: 24.36 cm
Microlens f #: 2.0
Hogel resolution: 480×270 (previously 240×135)
Elementary pixels per hogel: 8×8 (previously 16×16)
Hogel Size: 0.254×0.254 (previously 0.507×0.507 mm)
Distance of microlens array from display (f #x hogel size): 0.507 mm (previously 1.014 mm)

This modification doubles the hogel resolution, at the expense of halving the number of elementary pixels, resulting in smaller hogels and halving the distance between the microlens array and the underlying display.

The notional lightfield display that is being emulated is precisely the same as previously (shown in FIG. 32), except that, this time, it is emulated using 8:1 subsampling. Because the notional lightfield display is the same as previously, the depth of field remains the same at 8.85 cm. The previous design example could only display 2D images with a resolution of 240×135 pixels. In this design that is doubled to enable the display of 2D images with 480×270 pixel resolution.

This modified design uses 8:1 angular subsampling, rather than 4:1 used previously. The phase permutation may be generated as previously, that is, either by bit reversing linear phase order separately in the two dimensions, or by scanning the 2D linear phase order with a Hilbert (or similar) curve, permuting the order by bit reversal, and rescanning with a Hilbert curve (as illustrated in FIG. 35). A further alternative might be to select a subsampling phase for each hogel at (pseudo) random from the 64 available 2D phases.

For simplicity, this modified design example bit reverses the linear phase order to generate the subsampling phases. For 8:1 subsampling the linear phase order is (0, 1, 2, 3, 4, 5, 6, 7), represented in binary notation by (000, 001, 010, 011, 100, 101, 110, 111), bit reversing yields (000, 100, 010, 110, 001, 101, 011, 111), giving a permuted phase order of (0, 4, 2, 6, 1, 5, 3, 7). Applying this permuted phase order independently both horizontally and vertically gives the 2D array of subsampling phases, for each hogel, illustrated in FIG. 37.

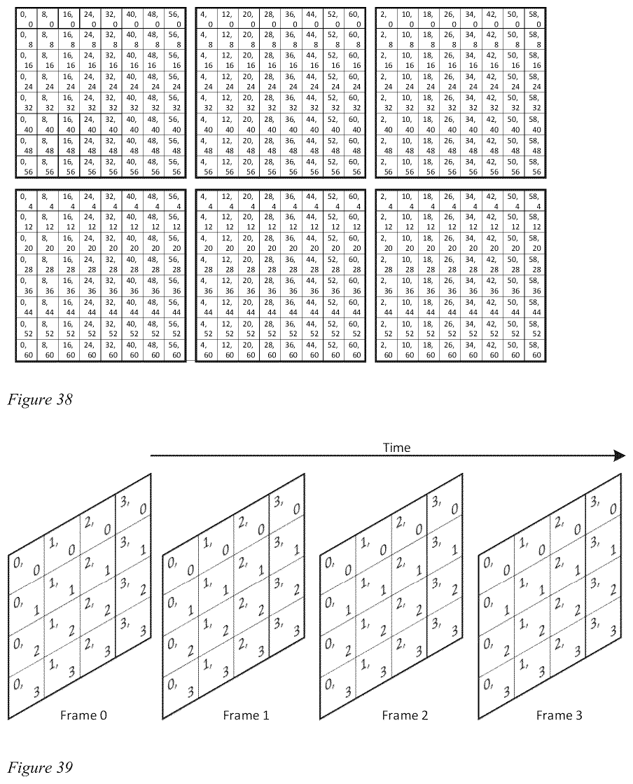

The mapping of the notional elementary pixels' coordinates (FIG. 37) to the physical display, is shown in FIG. 38. As before only the 6 top left hogels are shown, the rest may be extrapolated from those shown. Here, in contrast to the earlier design example, the pixel coordinates (both horizontal and vertical) increment by 8 rather than by 4.

Whilst this modified design example illustrates 2:1 oversampling, larger oversampling ratios may alternatively be used.

### Temporal Angular Subsampling

The technique of angular subsampling may be extended according to the present disclosure to take advantage of the time dimension. By doing so the depth of field of a lightfield display may be further increased. The technique of temporal subsampling may be used on its own, which is called “temporal angular subsampling” or in conjunction with spatial angular subsampling (described above), when it is called “spatiotemporal angular subsampling” (described in more detail below). It may also be combined with oversampling (described in the previous section). This section describes temporal angular subsampling and provides an illustrative example.

In the same way that a one-dimensional lightfield display, illustrated in diagrams herein, may be extrapolated to two spatial dimensions, it may also be extrapolated to a third dimension of time. The premise of spatial angular subsampling is that only one ray, of many possible rays, need be captured by an eye (or camera) in order to evoke the same image on the retina (or camera sensor). Similarly, a ray does not have to be present all the time in order to evoke a response. In the eye this is the phenomenon of persistence of vision. With a camera you need only capture a single ray during the time its shutter is open to form the image. However, if a ray only persists for a short time, it needs to have proportionately greater luminous intensity to have the same effect as a continuous ray.

A lightfield display may divide the generation of image rays (or beams) not only between hogels spatially, but alternatively (or additionally) over time. Spatial angular subsampling distributes image rays between nearby hogels. Analogously, temporal angular subsampling distributes image rays between image frames presented at different instants of time. The image rays generated in each frame are slightly different. Distributing the generation of image rays across frames means that the physical lightfield display can emulate a notional display with more elementary pixels per hogel and hence achieve a greater depth of field.

The variation of ray angle with time may be implemented, for example, using time varying prisms, e.g. using liquid crystals, described above (see FIG. 16). Variation of the ray angles with time when implementing temporal angular subsampling could instead be achieved by physically moving either a pinhole array parallax barrier or a microlens array (or parts thereof) laterally relative to the pixels of the display. Since the amount of movement required is very small this could, for example, be achieved by mounting the parallax barrier/microlens array (or parts thereof) using electrically controllable piezoelectric crystals. In further examples, a parallax barrier may be formed using an LCD enabling the position of the barrier to change from one display frame to another.

Ray angles may also be varied with time by physically moving a pixel array laterally relative to the associated light distribution control arrangement. Again, this could be achieved by mounting the pixel array using electrically controllable piezoelectric crystals.

Image interpolation may be used to vary the image rays generated with time by applying different lateral offsets to an elementary image in different display frames.

Temporal angular subsampling may be explained by way of an example. Consider a simple existing lightfield display with only a 2×2 array, i.e. 4 elementary pixels, per hogel. Applying 4:1 temporal angular subsampling means that ray angles can be generated across 4 consecutive frames. Hence this simple lightfield display can emulate a notional display with 4 times as many elementary pixels, that is, with a 4×4 array of elementary pixels, per hogel. The elementary pixels' coordinates for one hogel from this enhanced notional display are shown in FIG. 39.

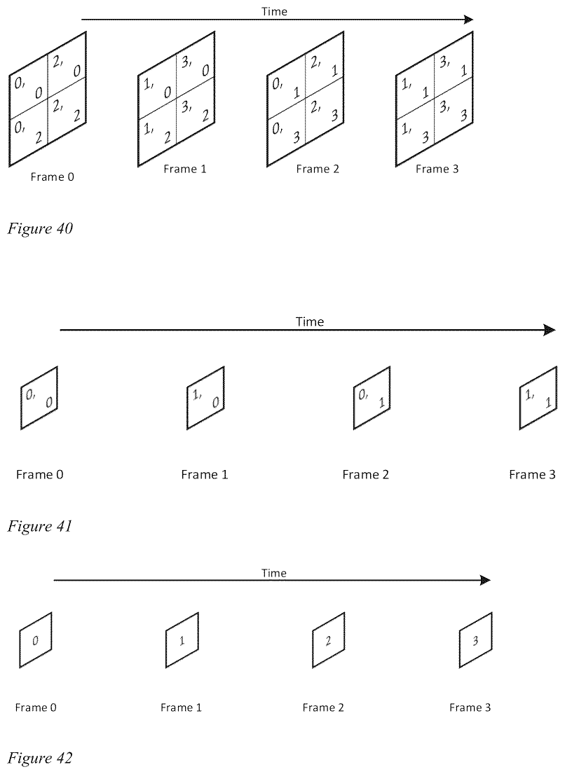

To implement temporal angular subsampling some of the pixel coordinates from the notional display are mapped to the physical display. Only one quarter of the notional pixel coordinates are mapped in this example of temporal subsampling. The notional pixel coordinates that are mapped to the physical elementary pixel always come from the corresponding frame in the notional display. That is, pixel coordinates from frame 0 of the notional display are mapped to frame 0 of the physical display, and so on. FIG. 40 enumerates how pixels are mapped from the notional to the physical display (for one hogel). The top left coordinate is different in each hogel in FIG. 40. That is, each hogel in the notional display (FIG. 39) is subsampled with a different spatial phase. The subsampling phase is defined by the top left coordinate in FIG. 40. Hence, we have a 4 frame sequence of subsampling phases defined in FIG. 41.

The subsampling phases, defined in FIG. 41, may be labelled as enumerated in FIG. 42.

Since there are 4 possible phases, each used once, in any of 4 possible positions, there are a total of 4 factorial (24) possible permutations of these phases. Any one of these permutations may be used to implement spatial subsampling in this example. However, with 4:1 temporal subsampling, there seems little advantage to using any particular permutation of temporal phases.

### Spatiotemporal Angular Subsampling

The purpose of angular subsampling is to increase the depth of field by reducing the number of elementary pixels per hogel that are required. Two approaches to angular subsampling, spatial and temporal subsampling, have been described. This section describes the combination of these two approaches, “spatiotemporal angular subsampling”, to provide a greater increase in the depth of field than either could provide alone.

This section starts by providing a simple, illustrative, example of spatiotemporal angular subsampling. The example considers an extremely simple lightfield display consisting of a 2×2 array of hogels, each with a 2×2 array of elementary pixels. It utilizes 2:1 spatial subsampling, both horizontally and vertically, combined with 4:1 temporal subsampling. The example is far too limited to be of practical utility and is presented here only to illustrate the principle. A more realistic design example is presented below.

FIG. 43 enumerates the spatial coordinates of the elementary pixels in each hogel of the physical display.

By implementing spatiotemporal angular subsampling this physical lightfield array can emulate a notional display with four times as many elementary pixels in each direction, i.e. with an 8×8 array of elementary pixels per hogel. The elementary pixels' coordinates for this notional display are shown in FIG. 44.

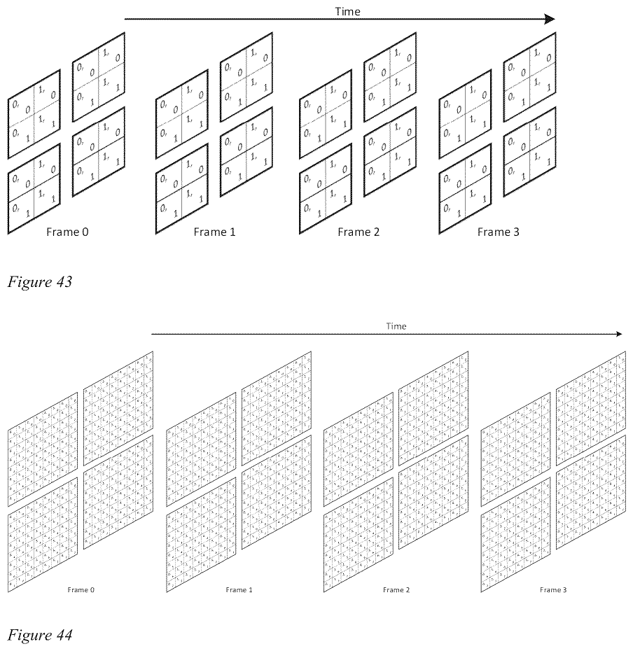

Unfortunately, the numerals for the coordinates are (necessarily) rather small and may be difficult to read. However, the coordinates are the same for every hogel in all frames and are presented, at a more readable resolution, in FIG. 45.

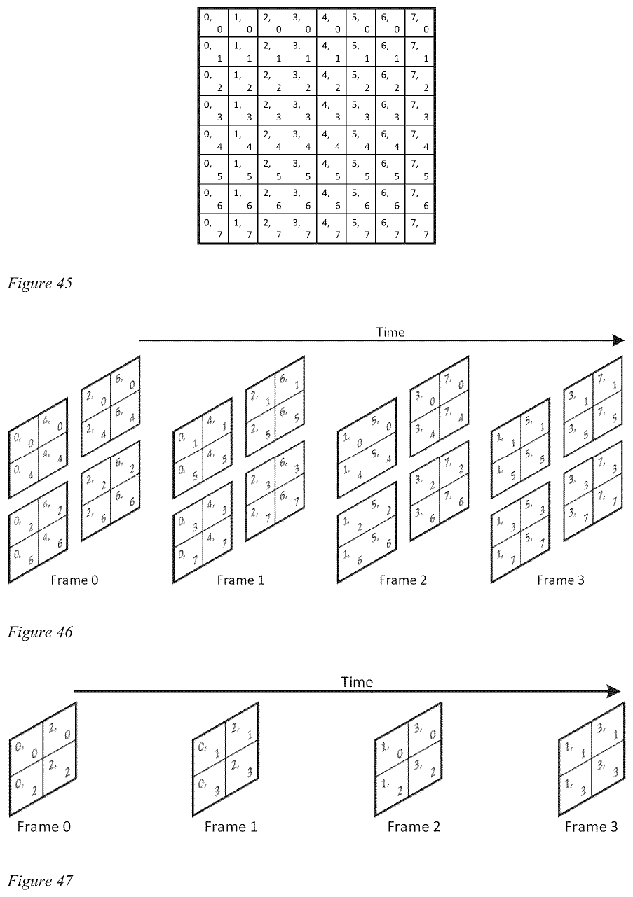

To implement spatiotemporal angular subsampling only one sixteenth of the notional pixel coordinates are subsampled and mapped to the physical display. The pixel coordinates mapped to the physical elementary pixel always come from the corresponding hogel, and the corresponding frame, in the notional display. That is, pixel coordinates from the top left notional hogel in frame 0 are mapped to the top left physical hogel in frame 0, and so on. FIG. 46 enumerates how pixels may be mapped from the notional to the physical display.

The top left coordinate is different in each hogel and each frame in FIG. 46. That is, each hogel in the notional display (FIG. 44) is subsampled in a different phase. The subsampling phase is defined by the top left coordinate of each hogel in FIG. 46. Hence, we have the 2×2×4 array of subsampling phases as enumerated in FIG. 47. Since there are 16 possible phases, each used once in any of 16 possible positions, there are a total of 16 factorial (i.e. 20,922,789,888,000) possible permutations of these phases. Many of these permutations may produce high quality images; there is no unique “best” permutation. DESIGN EXAMPLE USING SPATIOTEMPORAL ANGULAR SUBSAMPLING To clarify further, the design example above (Section “example design of a lightfield display using angular subsampling and phase permutation”, FIGS. 32-36) may be enhanced to implement spatiotemporal angular subsampling. The design parameters for the physical display are exactly as before and are reprised below.

### Design Parameters:

Screen size: 12.18×6.85 cm
Display resolution: 3840×1920
Assumed viewing distance: 24.36 cm
Microlens f #: 2.0
Hogel resolution: 240×135
Elementary pixels per hogel: 16×16
Hogel Size: 0.507×0.507 mm

As noted above, the pixels may be provided by any one of a range of known display types. As also described above, temporal angular subsampling may be implemented using adaptive liquid crystal prisms as discussed by Chen et al for example. The prisms may be controlled in synchronism with the pixels by a suitable display driver to provide spatiotemporal angular subsampling. The display driver may be in the form of a suitably programmed processor embedded in a field programmable gate array (FPGA) or application specific integrated circuit (ASIC), driving the liquid crystal prisms in the same way as an LCD display, with signals to both pixels and prisms synchronized (phased locked) to frame synchronization pulses. The FPGA output would drive one or more (depending on the hogel resolution) readily available LCD Timing Controllers (Tcons, such as Parade Technologies, Ltd DP808-4 Lane HBR3 eDP 1.4b PSR2 Tcon), via embedded DisplayPort (eDP) interfaces. Alternatively, the display driver may comprise a suitably programmed graphics processing unit (GPU) generating signals for both the pixels and the LCD liquid crystal prisms via synchronized eDP interfaces and Tcons.

In this enhanced example the display is implemented using 4:1 spatial subsampling (both horizontally and vertically) combined with 4:1 temporal subsampling. With these subsampling ratios the physical display may emulate a notional display with 8 times as many pixels both horizontally and vertically. That is, the physical display, with only 16×16 elementary pixels per hogel, can emulate a notional display with 128×128 elementary pixels per hogel. This is twice the number (in each dimension) as the initial design example (FIG. 32), because the generation of rays is now distributed over 4 frames, rather than having to be generated in a single frame, thus increasing the effective (notional) number of elementary pixels, allowing a very much greater depth of field.

The depth of field for this extended design may be calculated from Equations 8 and 9 using the same parameters as previously (x₀=0.507 mm, f #=2, and v=24.36 cm), except that the value for Ne is now the number of elementary pixels in the notional display that is being emulated, i.e. Nₑ=128. These parameters yield a depth of field (in terms of angular resolution, equation 9) of 27.78 cm, compared to only 1.74 without any subsampling and 8.85 cm with only spatial subsampling. Whilst a depth of field of only 1.74 cm might be considered of limited utility, increasing it to 27.78 cm is a significant improvement, providing a much more practical 3D display.

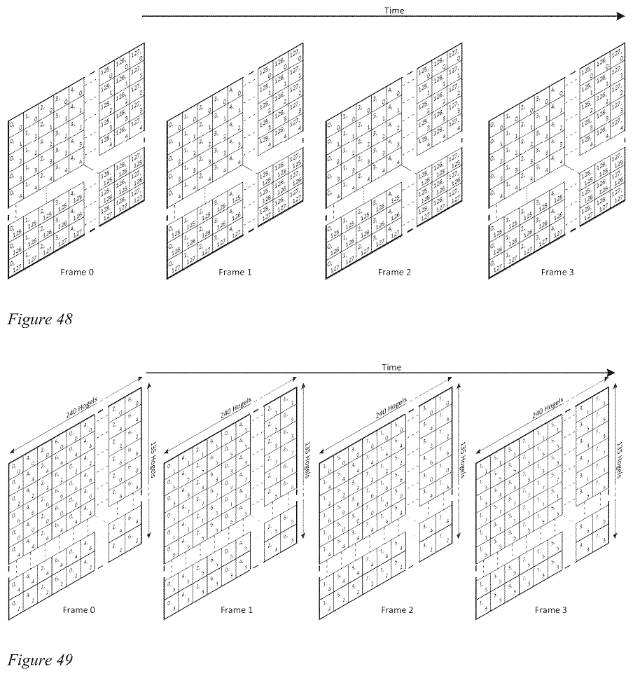

The elementary pixel coordinates for the notional display are as enumerated in FIG. 48. In this case there is only space to enumerate the elementary pixel coordinates for the top left hogel. However, all the other hogels have the same elementary pixel coordinates.

For simplicity, this enhanced design applies phase permutation separately in each of the 3 dimensions. As noted previously, for 4:1 temporal subsampling, there is little advantage to any particular permutation of temporal phases. So, this design uses the temporal phase permutation enumerated in FIG. 47 above. Spatially (independently horizontally and vertically) this design essentially uses the bit reversed phase permutation (0, 2, 1, 3). Now, however, due to temporal subsampling, the spatial phase increment is doubled. This approach yields the overall phase permutation enumerated in FIG. 49.

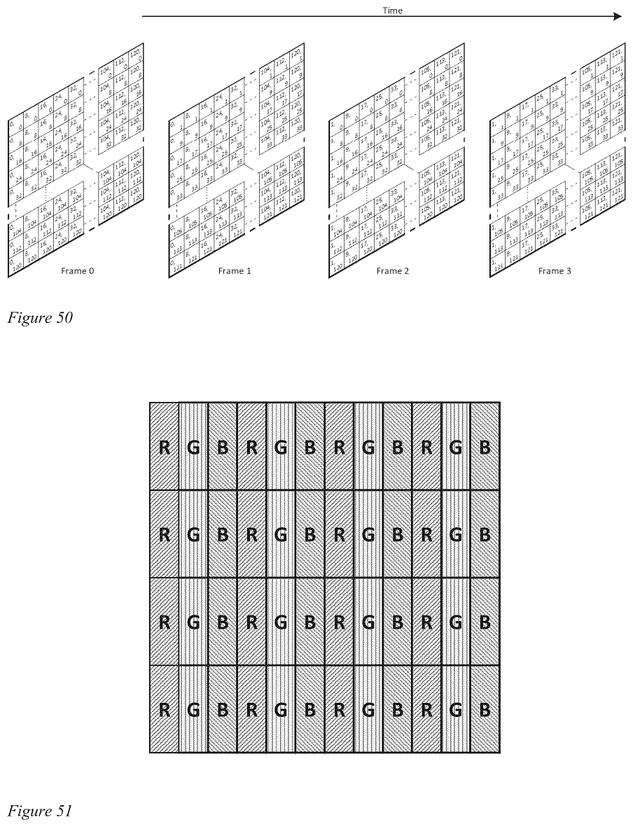

This phase permutation yields the mapping from the notional elementary pixel coordinates to the physical elementary coordinates that is enumerated in FIG. 50. There is only space to enumerate the mapping for the top left hogel and for 4 frames from the image sequence. Here, in contrast to the earlier design example, notional coordinates increment by 8 (horizontally and vertically), rather than by 4, in adjacent physical elementary pixels. This applies to all hogels, not just the top left hogel. The mapping of notional coordinates to any physical elementary pixel (in any hogel) may be determined from the initial phase enumerated in FIG. 50.

The subsampling phases enumerated in FIG. 49 represent only one of many effective phase permutations. There are 4 possible phases in each dimension, which may be represented as a 3 dimensional, 4×4×4, cube of phases. These 64 possible phases can be permuted in 64 factorial ways, which is an unimaginably large number. The permutation of the phases may be such that the magnitudes of adjacent phases differ as much as possible. One way in which this may be achieved for spatiotemporal subsampling is analogous to the process illustrated above for spatial subsampling (FIG. 29). That is, an effective alternative permutation may be produced by scanning the, 3-dimensional, 4×4×4, cube of permutations with a 3D Hilbert curve (or similar) to produce a 1 dimensional list of phases. Then the order of the scanned list of permutations is bit reversed. Finally, the bit reversed list of permutations is rescanned using another 3D Hilbert curve (or similar), to produce a permuted 4×4×4 cube of phases. As in FIG. 49 this cube of phases is tessellated (in 3 dimensions) to cover all the hogels in the frame and all frames in the sequence.

There are many space filling curves similar to Hilbert curves, such as Moore curves, and Lebesgue curves (a.k.a. z-order curves). See, for example, Bader M., Bungartz Hi., Mehl M. (2011) Space-Filling Curves. In: Padua D. (eds) Encyclopedia of Parallel Computing. Springer, Boston, MA.

In some circumstances, a lightfield display may have a small number of pixels per hogel, or even just a single pixel per hogel.

The number of hogels defines the resolution. The required depth of field determines the number of elementary pixels per hogel. For example, there may be 1000 hogels each 1 mm wide (and high), and 64×64 pixels per hogel (without subsampling). With spatial angular subsampling, a subsampling ratio may be determined as the size of the emanating region at infinity, which is the assumed diameter of the eye's pupil (say 4 mm), divided by the size of a hogel. In this example, there would be an angular subsampling ratio of 4:1.

With a subsampling ratio of 4:1, only 16×16 elementary pixels would be needed per hogel.

If the hogels are made eight times smaller and eight times as many are provided, there would be an eight times higher subsampling ratio, now 32:1, and consequently only eight times fewer elementary pixels would be required per hogel, that is, 2×2 pixels per hogel (thereby applying oversampling as described above).

Through combination with temporal angular subsampling, or decreasing the hogel size still further, it is possible to achieve an array size of only 1×1, that is, one elementary pixel per hogel.

With a sufficiently high subsampling ratio, only one elementary pixel per hogel may be required. The subsampling ratio can be made high by reducing the size of the hogel (limited only by diffraction). Each hogel may be a single color, as described below in the section on color.

With only a single elementary pixel per hogel, the structure of the hogel may be simplified. A unidirectional pixel such as a laser diode may be the light source, which would mean that a pinhole or lens may not be required to collimate the light. An offsetting optical arrangement such as a space/time varying prism may be used to control the direction of the ray/beam from the hogel.

### Color in Lightfield Displays

The forgoing discussion elides the issue of color in lightfield displays; it treats them as if they were monochrome. However, color may be an important aspect of a display. This section discusses how color lightfield images may be created.

There are many ways in which color is implemented in existing 2D displays. They typically entail small regions of the display producing different colors, where each colored region can be independently controlled. When the colors from nearby regions are combined in the eye (by blurring) many different aggregate colors can be achieved. For example, each known 2D pixel may be subdivided into red, green, and blue (RGB) regions. This may be done by implementing RGB stripes as illustrated in FIG. 51.

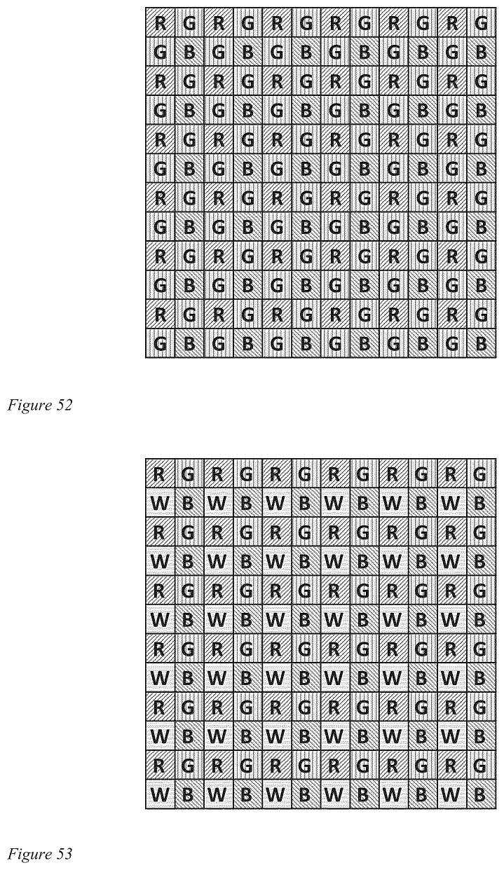

Here each pixel is made from a set of red, green, and blue stripes which are three times as high as they are wide, and independently controllable. Overall, the colored pixel is nine times the size of its smallest feature. The colored regions are typically implemented by color filter arrays, although OLED displays would use regions that emit different colors. Many other color filter array (or emission color array) patterns are possible, such as the well-known Bayer pattern shown in FIG. 52.

The Bayer pattern, often used as a color filter array in cameras as well as for displays, uses two green sub-pixels in each colored pixel. Since the eye is more sensitive to the color green this allows a brighter display. An advantage of the Bayer pattern is that the colored pixel is only four times the size of the smallest feature size (compared to 9 for stripes). One can also include more than the three primary colors, which is useful even though the retina only has cones which sense red, green, and blue. One such example is a red, green, blue and white array as illustrated in FIG. 53. The inclusion of the achromatic white region allows brighter displays at the expense of color desaturation in bright highlights.

Many different arrangements of colored sub-pixels regions are possible and many are known in existing display technology (see for example www.quadibloc.com/other/cfaint.htm). Each arrangement may have different features and trade-offs, such as, inter alia, brightness, color gamut and spatial resolution. Note that such color filters are not limited to a 2×2 arrangement of sub-pixels, nor even to a rectangular sampling lattice.

Color filter arrays, or colored emitters, may be used to create color in lightfield displays. One approach is to implement elementary lightfield pixels in the same way as 2D display pixels. That is, to subdivide the elementary pixels into sub-pixels of different colors. However, a key issue with lightfield displays is the large number of elementary pixels that are required. Subdividing elementary pixels into colored regions makes it more difficult to achieve the necessary number of elementary pixels.

An alternative way of producing colored lightfield displays, when based on LCDs, is to apply the color filter to the hogels rather than to the elementary pixels. The elementary pixels would emit white light, which would be filtered for each hogel. All the beams from one hogel would be the same color, which would differ from neighboring hogels. Again, since the eye would combine rays from multiple hogels into a point on the retinal image, the colored rays would be averaged to produce the correct overall color. This scheme is particularly attractive when combined with oversampled lightfield displays (because of their smaller hogel spacing).

For an emissive display technology, such as OLED or microLED, the whole elementary image in a hogel could emit a single color. Again, all the beams from one hogel would be the same color, which would differ from neighboring hogels. And, once again, the eye would combine beams from multiple hogels to produce the desired overall color.

An advantage of each hogel emitting a single color is that their optics (lenses and/or prisms) do not suffer from the dispersion of different wavelengths. The optics for each color may be calibrated to be the same. This may be achieved by slight adjustments to an adaptive liquid crystal lens associated with each hogel. Such adjustments could compensate for differences in refractive indices at different wavelengths. Alternatively, the rendering of images may be adjusted for each color to allow for slightly different sampling (including subsampling patterns).

Some places in this description use the term “rays”, whilst other places use the term “beams”. In general, these terms may be considered as interchangeable. The term “ray” most accurately corresponds to a pinhole lightfield display which produces rays. “Beams” are produced by microlens array lightfield displays. Descriptions using the term “ray” should not be taken to exclude implementations using microlens arrays.

Illustrative, non-exclusive examples of inventive subject matter according to the present disclosure are described in the following enumerated paragraphs:
A1. A lightfield display for generating a 3D image, wherein the lightfield display comprises:
a 2D array of hogels, with each hogel comprising:
   a 2D array of one or more pixels for generating light rays; and
   a light distribution control arrangement for controlling in 2D the angular distribution of the light rays from the array which are emitted by the hogel,
wherein the 2D array of each hogel is arranged to generate light rays which correspond to an elementary image assigned to the hogel, with each elementary image having a central axis which passes through a center of the image and extends perpendicular to the image, and wherein a plurality of the hogels have different lateral offsets between the light distribution control arrangement and the central axis of the respective elementary image.
A2. The display of paragraph A1, including a display driver coupled to the hogels for generating signals to control emission of light rays from the hogels.
A3. The display of paragraph A2, wherein the display driver is configured to control the plurality of the hogels such that each of the plurality of hogels generates first light rays corresponding to a first set of respective lateral offsets in a first display frame, and generates second light rays corresponding to a second set of respective lateral offsets different to its first set of lateral offsets in a second display frame, with the first and second display frames contributing to forming the same 3D image visible from the same position relative to the display.
A4. The display of any of paragraphs A1-A3, wherein intensities of the light rays from each of the one or more pixels of the plurality of hogels are interpolated intensities corresponding to the respective lateral offset.
A5. The display of any of paragraphs A1-A3, wherein each hogel is arranged to generate light rays at a set of ray angles relative to a central axis of its array of pixels and the plurality of hogels are arranged to generate different sets of ray angles to each other.
A6. The display of paragraph A5, wherein the plurality of hogels have different lateral offsets between their light distribution control arrangement and the central axis of the respective array of one or more pixels.
A7. The display of paragraph A5 or A6, wherein a plurality of the light distribution control arrangements are operable to change the angular distribution of the light rays from the pixels which are emitted by the respective hogel.
A8. The display of any of paragraphs A5-A7 when dependent on paragraph A3, wherein the display driver is configured to control the plurality of the hogels such that each of the plurality of hogels generates first light rays at a respective first subset of its set of ray angles relative to a central axis of its array of one or more pixels in a first display frame, and to change the direction of the light rays from the hogels with the light distribution control arrangement to generate second light rays at a respective second subset of its set of ray angles different to its first subset of ray angles relative to the central axis of its array of one or more pixels in a second display frame, with the first and second light rays contributing to forming the same 3D image visible from the same position relative to the display.
A9. The display of any of paragraphs A5-A8, wherein the light distribution control arrangement of each hogel comprises a parallax barrier which defines an aperture, with the respective array of one or more pixels located relative to the aperture such that light rays generated by each of the pixels of the array pass through the respective aperture.
A10. The display of paragraph A9, wherein the apertures associated with the plurality of hogels have different lateral offsets relative to the respective central axes of their arrays of one or more pixels.
A11. The display of paragraph A10, wherein the light distribution control arrangement is operable to adjust the lateral offset of the aperture of each of the plurality of hogels.
A12. The display of paragraph A11, wherein the light distribution control arrangement is operable to mechanically adjust the lateral offset of the aperture of each of the plurality of hogels.
A13. The display of any of paragraphs A9-A11, wherein each parallax barrier is formed by an LCD and the light distribution control arrangement is operable to adjust the lateral offset of the aperture of each of the plurality of hogels by controlling the LCD to move each parallax barrier.
A14. The display of any of paragraphs A1-A8, wherein the light distribution control arrangement of each hogel comprises a focusing optical arrangement, with each focusing optical arrangement spaced from the respective array by a focal distance.
A15. The display of paragraph A14, wherein each focusing optical arrangement has a central optical axis, and the central optical axes of the focusing optical arrangements associated with the plurality of hogels have different lateral offsets relative to the central axis of the respective array of one or more pixels.
A16. The display of paragraph A15, wherein the light distribution control arrangement is operable to adjust the lateral offset of each of the focusing optical arrangements.
A17. The display of paragraph A16, wherein the light distribution control arrangement is operable to mechanically adjust the lateral offset of each of the focusing optical arrangements.
A18. The display of any of paragraphs A1-A17, wherein the light distribution control arrangement of each hogel includes an offsetting optical arrangement for changing the direction of light rays emanating from the respective hogel.
A19. The display of paragraph A18, wherein each offsetting optical arrangement is controllable to alter the magnitude of the change it makes to the direction of light rays incident on the offsetting optical arrangement.
A20. The display of paragraph A18 or A19, wherein each offsetting optical arrangement comprises an offsetting prism.
A21. The display of paragraph A20, wherein each offsetting optical arrangement comprises an offsetting prism including liquid crystals.
A22. The display of paragraph A5, or any of paragraphs A6-A21 when dependent on paragraph A5, wherein the light rays are allocated to the plurality of hogels so as to interleave and to substantially evenly space apart the angles of the light rays emanating from adjacent hogels.
A23. The display of any paragraph A5, or any of paragraphs A6-A22 when dependent on paragraph A5, wherein the 2D array of hogels comprises a plurality of groups of hogels, with the hogels of each group arranged to generate different sets of ray angles to each other, and each group arranged to generate the same combination of ray angles.
A24. The display of any of paragraphs A1-A23, wherein the 2D array of hogels comprises a plurality of groups of hogels, with the hogels of each group arranged to have different lateral offsets between their light distribution control arrangement and the central axis of the respective elementary image, and each group arranged to generate the same combination of lateral offsets.
A25. The display of paragraph A24, wherein the hogels of each group are arranged to generate different lateral offsets between their light distribution control arrangements and the central axes of the respective elementary images in each of a plurality of display frames, and each group is arranged to generate the same combination of lateral offsets over the plurality of display frames.
A26. The display of any of paragraphs A23-A25, wherein the hogels of each group are arranged to generate different sets of ray angles to each other in each of a plurality of display frames, and each group is arranged to generate the same combination of ray angles over the plurality of display frames.
A27. The display of any of paragraphs A1-A26, wherein the 2D array of hogels comprises a plurality of groups of hogels, each hogel of each group of hogels defines a respective lateral offset and the lateral offsets of the group of hogels form an incremental sequence.
A28. The display of paragraph A27, wherein each hogel of each group of hogels defines a respective lateral offset in each of a plurality of display frames and the lateral offsets of the group of hogels in the plurality of display frames form an incremental sequence.
A29. The display of paragraph A27 or A28, wherein the lateral offsets of one of the groups are ordered differently in the display to the lateral offsets of another of the groups.
A30. The display of any of paragraphs A27-A29, wherein the lateral offsets of at least one of the groups have been ordered in the display by numbering each offset of the sequence in turn in binary, bit reversing the binary numbers, and then arranging the hogels of the group with reference to the sequence of the bit reversed binary numbers.
A31. The display of any of paragraphs A27-A29, wherein the lateral offsets of at least one of the groups have been ordered in the display by numbering each offset in turn in binary by scanning the group using a space filling curve, bit reversing the binary numbers to form a revised sequence, scanning the revised sequence using a space filling curve and then arranging the hogels of the group with reference to the sequence of the scanned revised sequence.
A32. The display of paragraph A5, or any of paragraphs A6-A31 when dependent on paragraph A5, wherein the light rays are allocated randomly to the plurality of hogels.
A33. The display of any of paragraphs A1-A32, wherein each array of one or more pixels includes pixels which generate light rays of different colors to each other.
A34. The display of any of paragraphs A1-A33, wherein each hogel generates light rays of a single color only.
A35. The display of paragraph A34, wherein each hogel includes a color filter arranged so that the light rays emanating from the hogel have passed through the color filter.
A36. The display of paragraph A34, wherein the pixels of each array of one or more pixels generate the same color as each other.
A37. A method of controlling the lightfield display of any of paragraphs A1-A36, comprising generating light rays with the 2D array of each hogel which correspond to an elementary image assigned to the hogel, wherein a plurality of the hogels have different lateral offsets between their light distribution control arrangement and the central axis of the respective elementary image.
A38. The method of paragraph A37, comprising generating first light rays corresponding to a first set of respective lateral offsets in a first display frame, and generating second light rays corresponding to a second set of respective lateral offsets different to its first set of lateral offsets in a second display frame, with the first and second display frames contributing to forming the same 3D image visible from the same position relative to the display.
A39. A method of controlling the lightfield display of paragraph A5, or any of paragraphs A6-A36 when dependent on paragraph A5, comprising controlling in 2D the angular distribution of the light rays from the array which are emitted by the hogel, wherein each hogel is arranged to generate light rays at a set of ray angles relative to a central axis of its array of pixels and a plurality of the hogels are arranged to generate different sets of ray angles to each other to form the 3D image.
A40. A method of controlling the lightfield display of paragraph A5, or any of paragraphs A6-A36 when dependent on paragraph A5, comprising controlling a plurality of the hogels such that each of the plurality of hogels generates first light rays at a respective first set of ray angles relative to a central axis of its array of pixels in a first display frame, and to change the direction of the light rays from the hogels with the light distribution control arrangement to generate second light rays at a respective second set of ray angles different to its first set of ray angles relative to the central axis of its array of pixels in a second display frame, with the first and second light rays contributing to forming the same 3D image at the same position relative to the display.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

1. A lightfield display for generating a 3D image, wherein the lightfield display comprises:
a 2D array of hogels, with each hogel comprising:
a 2D array of one or more pixels for generating light rays; and
a light distribution control arrangement for controlling in 2D the angular distribution of the light rays from the array which are emitted by the hogel,
wherein the 2D array of each hogel is arranged to generate light rays which correspond to an elementary image assigned to the hogel, with each elementary image having a central axis which passes through a center of the image and extends perpendicular to the image, and
wherein a plurality of the hogels have different lateral offsets between the light distribution control arrangement and the central axis of the respective elementary image.

2. The display of claim 1, including a display driver coupled to the hogels for generating signals to control emission of light rays from the hogels.

3. The display of claim 2, wherein the display driver is configured to control the plurality of the hogels such that each of the plurality of hogels generates first light rays corresponding to a first set of respective lateral offsets in a first display frame, and generates second light rays corresponding to a second set of respective lateral offsets different to its first set of lateral offsets in a second display frame, with the first and second display frames contributing to forming the same 3D image visible from the same position relative to the display.

4. The display of claim 1, wherein intensities of the light rays from each of the one or more pixels of the plurality of hogels are interpolated intensities corresponding to the respective lateral offset.

5. The display of claim 1, wherein each hogel is arranged to generate light rays at a set of ray angles relative to a central axis of its array of pixels and the plurality of hogels are arranged to generate different sets of ray angles to each other.

6. The display of claim 5, wherein the plurality of hogels have different lateral offsets between their light distribution control arrangement and the central axis of the respective array of one or more pixels.

7. The display of claim 5, wherein a plurality of the light distribution control arrangements are operable to change the angular distribution of the light rays from the pixels which are emitted by the respective hogel.

8. The display of claim 5, including a display driver coupled to the hogels for generating signals to control emission of light rays from the hogels,
wherein the display driver is configured to control the plurality of the hogels such that each of the plurality of hogels generates first light rays corresponding to a first set of respective lateral offsets in a first display frame, and generates second light rays corresponding to a second set of respective lateral offsets different to its first set of lateral offsets in a second display frame, with the first and second display frames contributing to forming the same 3D image visible from the same position relative to the display, and
wherein the display driver is configured to control the plurality of the hogels such that each of the plurality of hogels generates first light rays at a respective first subset of its set of ray angles relative to a central axis of its array of one or more pixels in a first display frame, and to change the direction of the light rays from the hogels with the light distribution control arrangement to generate second light rays at a respective second subset of its set of ray angles different to its first subset of ray angles relative to the central axis of its array of one or more pixels in a second display frame, with the first and second light rays contributing to forming the same 3D image visible from the same position relative to the display.

9. The display of claim 5, wherein the light distribution control arrangement of each hogel comprises a parallax barrier which defines an aperture, with the respective array of one or more pixels located relative to the aperture such that light rays generated by each of the pixels of the array pass through the respective aperture.

10. The display of claim 9, wherein the apertures associated with the plurality of hogels have different lateral offsets relative to the respective central axes of their arrays of one or more pixels.

11. The display of claim 10, wherein the light distribution control arrangement is operable to adjust the lateral offset of the aperture of each of the plurality of hogels.

12. The display of claim 11, wherein the light distribution control arrangement is operable to mechanically adjust the lateral offset of the aperture of each of the plurality of hogels.

13. The display of claim 9, wherein each parallax barrier is formed by an LCD and the light distribution control arrangement is operable to adjust the lateral offset of the aperture of each of the plurality of hogels by controlling the LCD to move each parallax barrier.

14. The display of claim 5, wherein the light rays are allocated to the plurality of hogels so as to interleave and to substantially evenly space apart the angles of the light rays emanating from adjacent hogels.

15. The display of claim 5, wherein the 2D array of hogels comprises a plurality of groups of hogels, with the hogels of each group arranged to generate different sets of ray angles to each other, and each group arranged to generate the same combination of ray angles.

16. The display of claim 15, wherein the hogels of each group are arranged to generate different sets of ray angles to each other in each of a plurality of display frames, and each group is arranged to generate the same combination of ray angles over the plurality of display frames.

17. The display of claim 5, wherein the light rays are allocated randomly to the plurality of hogels.

18. A method of controlling the lightfield display of claim 5, comprising controlling in 2D the angular distribution of the light rays from the array which are emitted by the hogel, wherein each hogel is arranged to generate light rays at a set of ray angles relative to a central axis of its array of pixels and a plurality of the hogels are arranged to generate different sets of ray angles to each other to form the 3D image.

19. A method of controlling the lightfield display of claim 5, comprising controlling a plurality of the hogels such that each of the plurality of hogels generates first light rays at a respective first set of ray angles relative to a central axis of its array of pixels in a first display frame, and to change the direction of the light rays from the hogels with the light distribution control arrangement to generate second light rays at a respective second set of ray angles different to its first set of ray angles relative to the central axis of its array of pixels in a second display frame, with the first and second light rays contributing to forming the same 3D image at the same position relative to the display.

20. The display of claim 1, wherein the light distribution control arrangement of each hogel comprises a focusing optical arrangement, with each focusing optical arrangement spaced from the respective array by a focal distance.

21. The display of claim 20, wherein each focusing optical arrangement has a central optical axis, and the central optical axes of the focusing optical arrangements associated with the plurality of hogels have different lateral offsets relative to the central axis of the respective array of one or more pixels.

22. The display of claim 21, wherein the light distribution control arrangement is operable to adjust the lateral offset of each of the focusing optical arrangements.

23. The display of claim 22, wherein the light distribution control arrangement is operable to mechanically adjust the lateral offset of each of the focusing optical arrangements.

24. The display of claim 1, wherein the light distribution control arrangement of each hogel includes an offsetting optical arrangement for changing the direction of light rays emanating from the respective hogel.

25. The display of claim 24, wherein each offsetting optical arrangement is controllable to alter the magnitude of the change it makes to the direction of light rays incident on the offsetting optical arrangement.

26. The display of claim 24, wherein each offsetting optical arrangement comprises an offsetting prism.

27. The display of claim 26, wherein each offsetting optical arrangement comprises an offsetting prism including liquid crystals.

28. The display of claim 1, wherein the 2D array of hogels comprises a plurality of groups of hogels, with the hogels of each group arranged to have different lateral offsets between their light distribution control arrangement and the central axis of the respective elementary image, and each group arranged to generate the same combination of lateral offsets.

29. The display of claim 28, wherein the hogels of each group are arranged to generate different lateral offsets between their light distribution control arrangements and the central axes of the respective elementary images in each of a plurality of display frames, and each group is arranged to generate the same combination of lateral offsets over the plurality of display frames.

30. The display of claim 1, wherein the 2D array of hogels comprises a plurality of groups of hogels, each hogel of each group of hogels defines a respective lateral offset and the lateral offsets of the group of hogels form an incremental sequence.

31. The display of claim 30, wherein each hogel of each group of hogels defines a respective lateral offset in each of a plurality of display frames and the lateral offsets of the group of hogels in the plurality of display frames form an incremental sequence.

32. The display of claim 30, wherein the lateral offsets of one of the groups are ordered differently in the display to the lateral offsets of another of the groups.

33. The display of claim 30, wherein the lateral offsets of at least one of the groups have been ordered in the display by numbering each offset of the sequence in turn in binary, bit reversing the binary numbers, and then arranging the hogels of the group with reference to the sequence of the bit reversed binary numbers.

34. The display of claim 30, wherein the lateral offsets of at least one of the groups have been ordered in the display by numbering each offset in turn in binary by scanning the group using a space filling curve, bit reversing the binary numbers to form a revised sequence, scanning the revised sequence using a space filling curve and then arranging the hogels of the group with reference to the sequence of the scanned revised sequence.

35. A method of controlling the lightfield display of claim 1, comprising generating light rays with the 2D array of each hogel which correspond to an elementary image assigned to the hogel, wherein a plurality of the hogels have different lateral offsets between their light distribution control arrangement and the central axis of the respective elementary image.

36. The method of claim 35, comprising generating first light rays corresponding to a first set of respective lateral offsets in a first display frame, and generating second light rays corresponding to a second set of respective lateral offsets different to its first set of lateral offsets in a second display frame, with the first and second display frames contributing to forming the same 3D image visible from the same position relative to the display.
